(19) United States
(12) Patent Application Publication
(10) Pub. No.: US 2007/0265434 A1
(43) Pub. Date: Nov. 15, 2007

(54) SIMPLIFIED METHOD TO RETRIEVE CHITOSAN FROM ACIDIC SOLUTIONS THEREOF

(76) Inventor: Jean-Guy Lehoux, Sherbrooke, Quebec (CA)

Correspondence Address: Choate Hall & Stewart, 2 International Pl Fl 34, Boston, MA, 02110-4104, US

(21) Appl. No.: 10/584,811

(22) PCT Filed: Dec. 24, 2004
(86) PCT No.: PCT/CA04/02202

§ 371 Date: Jul. 10, 2007

Related U.S. Application Data
(60) Provisional application No. 60/534,346, filed on Jan. 6, 2004.

(51) Int. Cl. C08B 37/08

(52) U.S. Cl. 536/20

(57) ABSTRACT

Composition of salted out chitosan polymer containing mixture of certain salting out salts as well as methods for making and using same are disclosed. Chitosan polymer preparations produced by such methods are substantially free of chitosanase, undesirable salts and excess acid and retain their physiological as well as biological and physico-chemical properties. The chitosan preparations of the present invention are valuable for the dispensing of biologically active chitosan in forms of drugs or food supplement. Most-of these preparations easily dissolve in an aqueous acidic milieu such as the one of the stomach.

### CROSS-REFERENCE TO RELATED APPLICATIONS

This application claims priority to U.S. provisional application No. 60/534,436 filed Jan. 6, 2004.

### FIELD OF THE INVENTION

The present invention relates to a simplified method for retrieving chitosan from aqueous acidic solutions. More specifically, the present invention concerns a method for retrieving chitosan from aqueous acidic solutions by addition of salts.

### BACKGROUND OF THE INVENTION

Chitosan is the deacetylated form of chitin, which is a linear polymer of N-acetyl-2-amino-β-D-glucose and contains high contents of amino and hydroxyl functional groups. This polycationic polymer is usually prepared commercially by limited hydrolysis of naturally occurring chitin from the exoskeleton of crustaceans and insects. Chitin is a polymer composed of N-acetyl-β-D-glucosamine (2-acetamido-2-deoxy-β-D-glucopyranose) monomeric units whereas commercially available chitosan is a heterogenous mixture of chitin of different molecular weights, deacetylated to various extents.

Chitosan possesses a wide variety of commercial and biomedical applications that are related to the size of the molecule and its degree of acetylation. With respect to biomedical applications, it has been reported that the hypocholesterolemic efficiency of chitosan increases in an inverse relationship to its size and percentage of acetylation (LeHoux et al. (1993) Some effect of chitosan on liver function in the rat. Endocrinology 132:1078-1084, Sugano et al. (1992) Hypocholesterolemic activity of partially hydrolyzed chitosans in rats. in Advanced in Chitin and Chitosan, Brine et al., (editors), Elsevier, London, pp. 472-478). Other studies have reported that chitosan molecules of 25 to 50 kiloDaltons (kDa) are efficient in the treatment of stomach ulcers (Ito et al. (2000) Anti-ulcer effects of chitin and chitosan, healthy foods, in rats. Japanese Journal of Pharmacology 82:218-225) and the prevention of tumor growth in a mouse model through the activation of intestinal immune functions (Maeda et al. (2004) Antitumor effects of various low-molecular-weight chitosans are due to increased natural killer activity of intestinal intraepithelial lymphocytes in sarcoma 180-bearing mice . . . Journal of Nutrition 134:945-950). Chitosan molecules of 28 kDa have been used as nanoparticles for the controlled release of drugs (medications) (Chen et al. (2003) Emulsification for the self-aggregation and nanoparticle formation of linoleic acid-modified chitosan in the aqueous system. Journal of Agriculture and Food Chemistry 51:3135-3139). Low molecular weight chitosans (LMWC) (≈2 kDa) have been used in agriculture as anti-fungal agents to protect tubercules, salads and tobacco seeds (Beaulieu et al. (2003) Potential use of chitosan in agriculture: growth stimulation and biological control of plants disease. 9^{th} International Chitin-Chitosan Conference, Montreal, Quebec, Canada, August 27-30). In contrast, chitosan of 400 kDa has been shown to be a suitable vehicle in a DNA vaccination approach of desensitization to peanut allergens in mice (Roy et al. (1999 Oral gene delivery with chitosan-DNA nanoparticles generates immunologic protection in a murine model of peanut allergy. Nature Medicine 5:387-391). These few examples illustrate the remarkable array of applications of chitosan and the importance of the size of the chitosan molecule for specific applications. It follows that targeted applications of chitosan require a well-characterized product that must be prepared under rigorously reproducible conditions.

The molecular sizes of commercially available chitosans generally vary between 70 kDa and more than 1000 kDa, whereas the percentage of deacetylation is usually in the range of about 50-100%. The percentage of deacetylation of chitin and its depolymerization to yield chitosan are a function of the conditions of the chemical treatment with aqueous base. Extended treatments lead to more fragmented molecules of chitosan, a property known as polydispersion. Polydispersed chitosan preparations are less desirable based on the observations of its size- and deacetylation-related properties, as discussed above.

Controlled enzymatic hydrolysis of commercially available chitosan polymers is the only reproducible method that exists to generate a product possessing a low dispersity and defined molecular weight properties. The physical characteristics of the starting material (chitosan) are important (size, percentage of acetylation) because they will influence the conditions of enzymatic digestion. Commercial chitosans vary in size and this property influences the time required for the production of depolymerized chitosans of defined molecular sizes for commercial applications in the areas of biomedicine, agriculture, cosmetics and others.

Enzymatic digestion of chitosan with a chitosanase is the only method that can be used to reproducibly generate LMWC with a low degree of polydispersity. Chitosanase is an enzyme that possesses a high degree of specificity for chitosan (Brzezinski (1996) Enzyme of use in chitosan hydrolysis. U.S. Pat. No. 5,482,843). Chitosan digestion with chitosanase is performed in a weakly acidic solution. Several experimental conditions must be controlled, among which are:

The enzymatic digestion must be rapidly stopped to prevent further depolymerization of chitosan and the generation of a polydispersed product.

An easy-to-use methodology must be employed to isolate the product of digestion rapidly and in a solid form that facilitates drying, ideally into a powder form. This consideration is highly desirable when large quantities (e.g. several hundred kilograms) of chitosan are to be processed for commercial purposes.

The product of digestion must be free of the enzyme (chitosanase).

The hydrolyzed product must be isolated under conditions that make it fit for human uses, especially when applications in the biomedical field are sought.

In the case of the use of chitosan as a food supplement, the product of hydrolysis must easily dissolve in an aqueous acidic milieu such as the one of the stomach. This condition limits the number of methodologies that can be used to retrieve the product from the acidic solution used for its enzymatic digestion or from other processes.

A number of methodologies have been used to isolate chitosan from aqueous acidic solutions. The most commonly used technique is to decrease the solubility of chitosan by raising the pH through addition of an inorganic base (as an example, sodium or potassium hydroxide). This procedure is very efficient to precipitate chitosan from such solutions but it suffers from the fact that the resulting mixture is highly viscous, making the isolation of precipitated chitosan difficult by conventional techniques of separation. Furthermore, the desired product must be free of excess base. This can be accomplished only at the expense of extensive washings, an approach that is time-consuming and that results in an appreciable loss (mechanical or by dissolution) of chitosan. Another aspect that ought to be taken into account when chitosan is hydrolyzed by treatment with a chitosanase is the possibility that chitosanase is concomitantly precipitated and may still remain active due to its resistance to pH treatment and/or remains as a contaminant in the processed product after the precipitate has been freed of excess base. One further point of paramount importance is that the final product must be free of contaminating alkali, especially if it is to be used for biomedical purposes.

An often efficient method of precipitation of chitosan from aqueous solutions consists in the addition of polyphosphoric acid (Shu et al. (2002) The influence of multivalent phosphate structure on the properties of ionically cross-linked chitosan films for controlled drug release. European Journal of Pharmacology and Biopharmacology 54:235-243) or polyphosphate salts (Chiou et al. (2003) Method of adsorbing dye in aqueous solution by chemical cross-linked chitosan beads. US Patent Application publication No. 20030101521. The phosphate salts of chitosan are insoluble in aqueous media. However, the major drawback of this method is that the phosphate salts of chitosan are poorly soluble in a physiological acidic environment such as the gastric milieu of the stomach.

It is of interest to point out further, that heat has been used to stop the action of chitosanase when chitosan is prepared by treatment with a chitosanase. In this instance, the inherent stability of chitosanase to heat denaturation requires raising the temperature of the reaction to 60° C. or more. This temperature favors the well-described and known Maillard reaction (O'Brien et al. (editors) (1998) The Maillard reaction in food and medicine. Royal Society of Chemistry, Cambridge, UK; Ikan. (editor) (1996) The Maillard reaction. John Wiley & Sons, New York, N.Y., USA) which leads to partial decomposition of chitosan and the generation of colored products resulting from the reaction of the primary amines of the chitosan molecules. This behavior is highly undesirable since these same amino groups are important for the biological properties of chitosan. Two additional points are of further interest. First, heat-denatured chitosanase may precipitate and be carried over in the subsequent steps of isolation of chitosan (e.g. by precipitation). Second, the partial resistance of chitosanase to heat denaturation may allow its renaturation and partial recovery of activity, adding to the possibility of further digestion of chitosan.

Overall, the current methods of precipitation and isolation of chitosan from chemical or enzymatic hydrolysates are therefore not adequate. Easy-to-use methodologies providing high yields of chitosan suitable for commercial uses, and especially for biomedical uses are of the utmost interest. The current art to isolate chitosan from aqueous acidic solutions, by raising the pH thereof by the addition of alkali or the formation of insoluble salts of chitosan does not fulfill these requirements.

Therefore, there remains a need for a simple, reliable, reproducible method for retrieving chitosan in high yields from chemical or enzymatic hydrolysates and which is suitable for commercial uses, and especially for applications related to the food and biomedical industries.

There is also a need for a method for retrieving chitosan from acidic solutions which would provide a product free of contaminants (e.g. chitosanase, undesirable salts) and which is easily dissolved in aqueous acidic milieu compatible with human use.

The present invention seeks at satisfying these needs and other needs. The present description refers to a number of documents, the content of which is herein incorporated by reference in their entirety.

### SUMMARY OF THE INVENTION

In a broad sense, the present invention therefore relates to a chitosan preparation and method of preparation thereof.

In one embodiment, the present invention concerns a method for retrieving chitosan from aqueous acidic solutions. In an embodiment, the present invention relates to a method for retrieving chitosan from aqueous acidic solutions by the addition of salting out salts (e.g. kosmotropic salts, mixture thereof, mixture of chaotropic and kosmotropic salts, etc), such as food compatible and biomedically compatible inorganic or organic salts.

In an embodiment, the present invention relates to a method for retrieving chitosan from acidic solution by means of the addition of a salting out agent such as the salt of an inorganic acid. In a further embodiment, the present invention relates to a method for retrieving chitosan from acidic solutions by means of the addition of a salt of an organic acid suitable for human ingestion. The addition of a salting out salt (and combination thereof or kosmotropic salts (and combination thereof), or a combination of kosmotropic and chaotropic salts creates a salting out effect by reorganizing water molecules with the added salt resulting in the dehydration of the dissolved chitosan molecules and their precipitation from solution.

In one embodiment, the salting out reaction is performed under non-denaturating conditions. Non-limiting examples of pH values that may be used in accordance with the present invention are between about 3 and about 7 (e.g. 3, 3.5, 4, 4.5, 5, 4.5, 6, 6.5, and 7). Non-limiting examples of temperatures at which the methods of the present invention may be performed include temperatures between about 4° C. and about 55° C. (e.g. 4, 6, 8, 10, 12, 14, 16, 18, 20, 25, 28, 30, 32, 35, 38, 40, 42, 45, 48, 50, 52, 55° C.). Temperatures higher (e.g. 60, 65, 68° C. etc) or lower (3, or 2° C.) may also be used in accordance with the present invention. For the sake of brevity, the units (e.g. pH of 3.2, 3.4, 5.7, 6.8 etc and temperature of 5, 7, 9, 21, 22° C. etc) have not been specifically recited but are nevertheless considered within the scope of the present invention.

The present invention further relates to a method for retrieving chitosan from acidic solutions, such retrieved chitosan having conserved the physical properties of native chitosan such as ionic charges and molecular sizes. Chitosan polymers of molecular weights approximating 7 to molecular weights approximating hundreds of kDa and higher (for example 300 centipoises) can be precipitated by the methods of the present invention. The methods described in the present invention further apply to chitosan polymers with degrees of acetylation approximating 0% to degrees of acetylation approximating at least 50%.

In addition, the present invention further relates to a method for salting out chitosan from acidic solutions enabling the production of a precipitated chitosan preparation having a non-viscous, fiber-like appearance. Therefore, such a chitosan preparation can easily be recovered from acidic solutions using simple conventional techniques such as ultrafiltration, centrifugation, or other known and usual methods of recovery of a solid phase from a liquid phase.

In another embodiment, the invention relates to a method of retrieving chitosan from acidic solutions suitable for purification from enzymatic hydrolysate's enabling the selective salting out of chitosan over chitosanase. This selective salting out prevents further hydrolysis of chitosan thus reducing its polydispersity and yielding in a chitosan preparation which is substantially free of chitosanase.

In a further embodiment, the present invention relates to a chitosan preparation containing negligible amounts of chitosanase. The present invention provides a method for recovering chitosan from acidic solutions; such recovered chitosan preparation can be easily freed of the salting out salt(s) (e.g. kosmotropic salts, mixture thereof and mixture of chaotropic and kosmotropic salts) as well as other soluble substances. In an embodiment, the chitosan preparations of the present invention achieve recovery levels of at least 90% (e.g. 90, 91, 92, 93, 94, 95, 96, 97, 98, 99, 100%). In another embodiment, the chitosan preparations of the present invention achieve recovery levels of at least 95% (e.g. 95, 96, 97 98 99 100%). In a further embodiment the chitosan preparations of the present invention achieve recovery levels of at least 98%.

In addition, the invention relates to a method for purifying chitosan from acidic solutions and to a preparation of chitosan obtained therefrom. Such purified chitosan preparation being suitable for human or animal consumption therefore satisfying the criteria required in biomedical applications or as a food additive.

In an embodiment, the invention relates to a method for purifying chitosan of various molecular sizes. The chitosan obtained by the methods of the present invention can easily be dried, and the ensuing powder is readily soluble in dilute organic and preferably inorganic acids such as hydrochloric acid solutions similar to the acid content of the stomach. This property is highly suitable in cases wherein the chitosan preparation is used as a food additive. In an embodiment, the present invention also relates to chitosan preparations of a chosen molecular size or sizes, which are readily soluble in dilute hydrochloric acid solutions. In an embodiment this dilute hydrochloric acid solution mimics the acid content of the stomach.

In another embodiment, the present invention relates to a chitosan preparation substantially or totally free of chitosanase, suitable for human consumption, soluble in an aqueous acidic milieu such as in the stomach and substantially free of precipitating salts (e.g. salting out salts).

Other advantages and features of the present invention will become more apparent upon reading of the following non-restrictive description of illustrative embodiments thereof, given by way of example only.

Unless defined otherwise, the scientific and technical terms and nomenclature used herein have the same meaning as commonly understood by a person of ordinary skill to which this invention pertains.

Definitions

The use of the word “a” or “an” when used in conjunction with the term “comprising” in the claims and/or the specification may mean “one” but it is also consistent with the meaning of “one or more”, “at least one”, and “one or more than one”.

Throughout this application, the term “about” is used to indicate that a value includes the standard deviation of error for the device or method being employed to determine the value. In general, the terminology “about” is meant to designate a possible variation of up to 10%. Therefore, a variation of 1, 2, 3, 4, 5, 6, 7, 8, 9 and 10% of a value is included in the term about.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

As used herein, the term “purified” refers to a molecule (e.g. chitosan) having been separated from a component of the composition in which it was originally present. Thus, for example, chitosan has been purified to a level not found in nature. A “substantially pure” molecule is a molecule that is lacking in most other components (e.g., 30, 40, 50, 60, 70, 75, 80, 81, 82, 83, 84, 85, 86, 87, 88, 89, 90, 91, 92, 93, 94, 95, 96, 97, 98, 99, 100% free of contaminants). By opposition, the term “crude” means molecules that have not been separated from the components of the original composition in which it was present (e.g. an acidic solution comprising chitosanase). Therefore, the terms “separating” or “purifying” refers to methods by which one or more components of the sample are removed from one or more other components of the sample. Sample components include extracts from the exoskeleton of insects or animals (including crustaceans etc) as well as commercially available chitosan preparation. The extracts may include all or parts of the components originally found in the natural source. Thus, apart from chitosan, the extract may include other components, such as proteins (e.g. chitosanase), carbohydrates, lipids or nucleic acids. In one embodiment, a separating or purifying step removes at least about 50% (e.g., 50, 55, 60, 65, 70, 75, 80, 85, 90, 95, 96, 97, 98, 99, 100%) of the other components present in the sample from the desired component. In another embodiment, the purifying step removes at least about 80% (e.g., 80, 81, 82, 83, 84, 85, 86, 87, 88, 89, 90, 91, 92, 93, 94, 95, 96, 97, 98, 99, 100%) and, in a further embodiment, at least about 95% (e.g., 95, 96, 97, 98, 99, 100%) of the other components present in the sample from the desired component. For the sake of brevity, the units (e.g. 66, 67 . . . 81, 82, . . . 91, 92% . . . ) have not systematically been recited but are considered, nevertheless, within the scope of the present invention.

“Acidic environment”, “acidic conditions” or “acidic pH level” is intended to cover all pH levels less than about 7. However, for the purpose of the present invention, pH levels of about 2 to about 6 are preferred pH levels when referring to an acidic solution for the salting out of chitosan from an acidic aqueous environment. Non-limiting examples of weak organic acids that may be used in accordance with the present invention include malic acid and lactic acid. Other examples of acids that may be used include acetic acid and chloric acid (HCl). In the case of acetic, lactic and malic acids, the preferred concentration is about 5 to 10%, on a volume basis. In the case of HCl, the preferred concentration is about 0.2N. Of course other concentrations of acids may be used in accordance with the present invention.

Precipitation occurs in solution when two chemicals react together or when conditions are changed (e.g. by the addition of salts, change in temperature, atmospheric pressure or pH of a solution) to form a product that is insoluble in solution and falls out of solution like rain or snow. A “precipitate” is a solid substance that separates from solution as a result of a chemical reaction or change in condition (e.g. salting out reaction). A precipitate can consists of more or less fine particles and may be identified by the cloudy, milky, gelatinous, or grainy appearance it gives to the mixture. The solid might even settle to the bottom of the container.

In a broad sense, the term solubility is defined as the ability or tendency of one substance to dissolve into another. The solubility of a compound may be total or fractional and varies depending on the physico-chemical characteristics of the solvent in which it is incorporated (e.g. temperature, pressure, pH, etc). The molar solubility is defined as the maximum amount of solute that will dissolve in mol per liter of solution. “The solubility” of a substance may also be expressed as the greatest amount (expressed either in grams or moles) that will dissolve in a specified volume of solvent under particular conditions.

Cloud point: For the purpose of the present invention, the cloud point is the concentration of salting out salts (e.g. kosmotropic salts, mixture thereof, mixtures of kosmotropic and chaotropic salts, salts of an organic or inorganic acid, etc) at which chitosan starts to precipitate under particular conditions (pH, temperature, molecular weight of chitosan, degree of deacetylation, ambient pressure and particular salt used for salting out). The cloud point may be determined by simple visual inspection (when the solution is no longer homogenous, i.e. when it becomes cloudy or turbid). The cloud point may also be determined by more precise analytical methods well known in the art by measuring the amount of chitosan precipitated by a given concentration of salt under given conditions (e.g. chitosan of a given molecular weight and of a certain degree of deacetylation at a given temperature and pH). Analytical methods that may be used in accordance with the present invention include calorimetric methods such as the method using the Cibracon brilliant red 3B-A dye developed by Muzzarelli (1998) (Colorimetric determination of chitosan. Analytical Biochemistry 260: 255-257), the picric acid method published by Neugebauer et al. (1989) (Determination of the degree of N-acetylation of chitin-chitosan with picric acid. Carbohydrate Research 189, 363-369), the less reliable (Hugerth et al. (1997) The effect of charge density and conformation on the polyelectrolyte complex formation between carrageenan and chitosan. Carbohydrate Polymers 34 149-156) ninhydrin method described by Curotto and Aros (1993) (Quantitative determination of chitosan and the percentage of free amino groups. Analytical Biochemistry 211:240-241) or methods derived therefrom. Other methods well known in the art, based for example on the use of antibodies specific for chitosan, may also be used in accordance with the present invention (e.g, immunoprecipitation or enzyme linked immunosorbant assays (ELISA)). Non-limiting examples of chitosan antibodies that may be used are given in Sorlier et al., (2003) (Preparation and development of anti-chitosan antibodies. Journal of Biomedical Material Research 67A:766-774).

The term “chaotropic” means chaos-forming, a term which in biochemistry, usually refers to a compound's ability to disrupt the regular hydrogen bond structures in water. This hydrogen bonding profoundly affects the secondary structure of biopolymers such as DNA, RNA, proteins and polysaccharides (e.g. chitosan) as well as their solubility in aqueous media. A chaotropic salt decreases structure (increases chaos) by breaking up hydrogen bonding and hydrophobic interactions. Non-limiting examples of chaotropic (destabilizers) salts include NaClO⁴, NaSCN, NaNO³ and NaBr. By opposition, kosmotropic (stabilizer) salts exhibit strong interactions with water molecules. Thus the water molecules become organized around the kosmotropic salt ions to such a degree that its normal organization around the solute is decreased and the solute is able to associate in a solid phase (i.e. precipitate). Non-limiting examples of kosmotropic (stabilizers) salts include Na²SO⁴, Na citrate, Na tartrate and NaH²PO⁴.

“Salting out”. The “salting out” effect decreases the solubility of the solute by increasing the organization of water molecules around the ions instead of the solute. It is primarily the result of the competition between the added salt ions and the other dissolved solutes for molecule of salvation. At high salt concentration, so many of the added ions are solvated that the amount of bulk solvent available becomes insufficient to dissolve other solutes (e.g. chitosan). Hence solute-solute interactions become stronger than solute-solvant interactions. This salting out effect results in the dehydration of the solute and its precipitation from solution (Collins and Washabaugh (1985) The Hofmeister effect and the behaviour of water at interfaces. Quarterly Review of Biophysics 18:323-422; Cacace et al., (1997) The Hofmeister series: salt and solvent effects on interfacial phenomena. Quarterly Review of Biophysics 30:241-277; Kunz et al. (2004) ‘Zur Lehre von der Wirkung des Salze’ (about the science of the effect of salts): Franz Hofmeister's historical papers. Current Opinion in Colloid and Interface Science 9:19-37). Thus, if the concentration of neutral salts is at a high level (e.g. >0.1 M), in many instances the protein precipitates. The decrease in solvation and neutralization of the repulsive forces allows the proteins to aggregate and precipitate.

Salting out salts. The salting out salts of the present invention are generally characterized by their ability to decrease chitosan solubility by increasing the organization of water molecules around them instead of chitosan (salting out effect). Thus, as used herein, the term “salting out salt” is meant to include any salt that causes the dehydration and precipitation of chitosan from an aqueous solution (e.g. kosmotropic salts, mixture thereof, inorganic or organic salts, mixtures of chaotropic and kosmotropic salts, etc).

The term “salt(s)” as used herein, is understood as being acidic and/or basic salts formed with inorganic and/or organic acids and bases. Zwitterions (internal or inner salts) are understood as being included within the term “salt(s)” as used herein, as are quaternary ammonium salts such as alkylammonium salts. Nontoxic, pharmaceutically acceptable salts are preferred, although other salts may be useful, as for example in isolation or purification steps.

Examples of acid addition salts include but are not limited to acetate, adipate, alginate, aspartate, benzoate, benzenesulfonate, bisulfate, butyrate, citrate, camphorate, camphorsulfonate, cyclopentanepropionate, digluconate, dodecylsulfate, ethanesulfonate, fumarate, glucoheptanoate, glycerophosphate, hemisulfate, heptanoate, hexanoate, hydrochloride, hydrobromide, hydroiodide, 2-hydroxyethanesulfonate, lactate, maleate, methanesulfonate, 2-naphthalenesulfonate, nicotinate, oxalate, pectinate, persulfate, 3-phenylpropionate, picrate, pivalate, propionate, succinate, tartrate, thiocyanate, tosylate, and undecanoate.

Examples of basic salts include but are not limited to ammonium salts; alkali metal salts such as sodium, lithium, and potassium salts; alkaline earth metal salts such as calcium and magnesium salts; salts comprising organic bases such as amines (e.g., dicyclohexylamine, alkylamines such as t-butylamine and t-amylamine, substituted alkylamines, aryl-alkylamines such as benzylamine, dialkylamines, substituted dialkylamines such as N-methyl glucamine (especially N-methyl D-glucamine), trialkylamines, and substituted trialkylamines).

The terms “halogen” or “halo” as used herein, is understood as being chlorine, bromine, fluorine and iodine.

The present invention is further illustrated by the following specific examples. The examples are provided for illustration only and should not be construed as limiting the scope of the invention in any way.

### BRIEF DESCRIPTION OF THE DRAWINGS

Having thus generally described the invention, reference will be made to the accompanying drawings, showing by way of illustration only an illustrative embodiment thereof and in which:

FIG. 1 shows the efficiency of trisodium citrate to salt out (i.e. precipitate) 92% deacetylated chitosan of various molecular sizes determined with a triple detector array apparatus equipped with a low angle light scattering device (Viscotek Corporation) from enzymatic hydrolysates of a 240 kDa chitosan (Vanson HaloSource). Experiments were conducted at 4° C.

FIG. 2 shows the efficiency of trisodium citrate to salt out (i.e. precipitate) 92% deacetylated chitosan of various molecular sizes determined with a triple detector array apparatus equipped with a low angle light scattering device (Viscotek Corporation, Houston, Tex., USA) from enzymatic hydrolysates of a 240 kDa chitosan (Vanson. HaloSource). Experiments were conducted at room temperature.

FIG. 3 shows the efficiency of ammonium sulfate to salt out (i.e. precipitate) 92% deacetylated chitosan of various molecular sizes determined with a triple detector array apparatus equipped with a low angle light scattering device (Viscotek Corporation) from enzymatic hydrolysates of a 240 kDa chitosan (Vanson HaloSource). Experiments were conducted at 4° C.

FIG. 4 shows the efficiency of ammonium sulfate to salt out (i.e. precipitate) 92% deacetylated chitosan of various molecular sizes determined with a triple detector array apparatus equipped with a low angle light scattering device (Viscotek Corporation) from enzymatic hydrolysates of a 240 kDa chitosan (Vanson HaloSource). Experiments were conducted at room temperature.

FIGS. 5a, 5b and 5c show the efficiency of sodium sulfate to salt out (i.e. precipitate) chitosan (30 kDa prepared by enzymatic hydrolysis, 92% deacetylated) at 4° C. (5a), room temperature (5b) and 50° C. (5c).

FIGS. 6a, 6b and 6c show the efficiency of trisodium citrate to salt out (i.e. precipitate) chitosan (30 kDa prepared by enzymatic hydrolysis, 92% deacetylated) at 4° C. (6a), room temperature (6b) and 50° C. (6c).

FIGS. 7a, 7b and 7c show the efficiency of ammonium sulfate to salt out (i.e. precipitate) chitosan (30 kDa prepared by enzymatic hydrolysis, 92% deacetylated) at 4° C. (7a), room temperature (7b) and 50° C. (7c).

FIGS. 8a, 8b and 8c show the efficiency of disodium tartrate to salt out (i.e. precipitate) chitosan (30 kDa prepared by enzymatic hydrolysis, 92% deacetylated) at 4° C. (8a), room temperature (8b) and 50° C. (8c).

FIGS. 9a, 9b and 9c show the efficiency of sodium phosphate monobasic to salt out (i.e. precipitate) chitosan (30 kDa prepared by enzymatic hydrolysis, 92% deacetylated) at 4° C. (9a), room temperature (9b) and 50° C. (9c).

FIGS. 10a, 10b and 10c show the efficiency of disodium malate to salt out (i.e. precipitate) chitosan (30 kDa prepared by enzymatic hydrolysis, 92% deacetylated) at 4° C. (10a), room temperature (10b) and 50° C. (10c).

FIGS. 11a, 11b and 11c show the efficiency of sodium nitrate to salt out (i.e. precipitate) chitosan (30 kDa prepared by enzymatic hydrolysis, 92% deacetylated) at 4° C. (11a), room temperature (11b) and 50° C. (11c).

FIGS. 12a, 12b and 12c show the efficiency of sodium phosphate dibasic to salt out (i.e. precipitate) chitosan (30 kDa prepared by enzymatic hydrolysis, 92% deacetylated) at 4° C. (12a), room temperature (12b) and 50° C. (12c).

FIGS. 13a, 13b and 13c show the efficiency of disodium succinate to salt out (i.e. precipitate) chitosan (30 kDa prepared by enzymatic hydrolysis, 92% deacetylated) at 4° C. (13a), room temperature (13b) and 50° C. (13c).

FIGS. 14a, 14b et 14c show the efficiency of sodium acetate to salt out (i.e. precipitate) chitosan (30 kDa prepared by enzymatic hydrolysis, 92% deacetylated) at 4° C. (14a), room temperature (14b) and 50° C. (14c).

FIGS. 15a and 15b show the efficiency of disodium malonate to salt out (i.e. precipitate) chitosan (30 kDa prepared by enzymatic hydrolysis, 92% deacetylated) at 4° C. (15a) and room temperature (15b).

FIGS. 16a, 16b and 16c show the efficiency of sodium lactate to salt out (i.e. precipitate) chitosan (30 kDa prepared by enzymatic hydrolysis, 92% deacetylated) at 4° C. (16a), room temperature (16b) and 50° C. (16c).

FIGS. 17a and 17b show the efficiency of sodium propionate to salt out (i.e. precipitate) chitosan (30 kDa prepared by enzymatic hydrolysis, 92% deacetylated) at 4° C. (17a) and room temperature (17b).

FIGS. 18a and 18b show the comparative efficiencies of salting out inorganic and organic salts used at a 1:1 (18a) and 4:1(18b) ratio to dissolved chitosans to salt out (i.e. precipitate) chitosan (30 kDa prepared by enzymatic hydrolysis, 92% deacetylated) at 4° C., room temperature and 50° C.

FIGS. 19a and 19b show the efficiency of ammonium sulfate to salt out (i.e. precipitate) chitosan (240 kDa from Vanson Halosource, 92% deacetylated) at 4° C. (19a) and room temperature (19b).

FIGS. 20a and 20b show the efficiency of sodium sulfate to salt out (i.e. precipitate) chitosan (240 kDa from Vanson Halosource, 92% deacetylated) at 4° C. (20a) and room temperature (20b).

FIGS. 21a and 21b show the efficiency of trisodium citrate to salt out (i.e. precipitate) chitosan (240 kDa from Vanson Halosource, 92% deacetylated) at 4° C. (21a) and room temperature (21b).

FIGS. 22a and 22b show the efficiency of sodium phosphate monobasic to salt out (i.e. precipitate) chitosan (240 kDa from Vanson Halosource, 92% deacetylated) at 4° C. (22a) and room temperature (22b).

FIGS. 23a and 23b show the comparative efficiencies of salting out inorganic and organic salts used at a 1:1(23a) and 4:1(23b) ratio relative to dissolved chitosan to salt out (i.e. precipitate) chitosan (240 kDa from Vanson Halosource, 92% deacetylated) at 4° C. and room temperature.

FIGS. 24a and 24b show the efficiency of ammonium sulfate to salt out (i.e. precipitate) a high molecular weight (HMW) chitosan (300 cps, 92% deacetylated, from Vanson Halosource) at 4° C. (24a) and room temperature (24b).

FIGS. 25a and 25b show the efficiency of sodium sulfate to salt out (i.e. precipitate) a high molecular weight (HMW) chitosan (300 cps, 92% deacetylated, from Vanson Halosource) at 4° C. (25a) and room temperature (25b).

FIGS. 26a and 26b show the efficiency of sodium phosphate monobasic to salt out (i.e. precipitate) a high molecular weight (HMW) chitosan (300 cps, 92% deacetylated, from Vanson Halosource) at 4° C. (26a) and room temperature (26b).

FIGS. 27a and 27b show the efficiency of trisodium citrate to salt out (i.e. precipitate) a high molecular weight (HMW) chitosan (300 cps, 92% deacetylated, from Vanson Halosource) at 4° C. (27a) and room temperature (27b).

FIGS. 28a and 28b show the comparative efficiencies of salting out inorganic and organic salts used at a 1:1 (28a) and 4:1(28b) ratio to dissolved chitosan to salt out (i.e. precipitate) a high molecular weight (HMW) chitosan (300 cps, 92% deacetylated, from Vanson Halosource) at 4° C. and room temperature.

### DESCRIPTION OF ILLUSTRATIVE EMBODIMENTS

An easy-to-use and reproducible protocol is described herein to allow high yields and quick recovery of chitosan dissolved in aqueous acidic solutions. The protocol is based on the principle of reorganization of the hydrated shell of the chitosan polymer by addition of salting out salts (e.g. kosmotropic salts, mixture thereof, mixture of chaotropic and kosmotropic salts, etc). Non-limiting examples of salting out salts include the sodium or potassium salts of citric acid, malic acid, tartaric acid, malonic acid, acetic acid, lactic acid, succinic acid, propionic acid or phosphoric acid. The ammonium, potassium or sodium salts of sulfuric acid and the sodium or potassium salts of nitric acid can also be used effectively in accordance with the present invention.

The protocol differs from previously used methods of recovery of chitosan from acidic solutions which use high pH or processes of coagulation. The method of the present invention offers a number of advantages such as: a) safety of operation due to the use of non-corrosive reagents; b) high yields of recovery of chitosan; and c) a lack of modification of the physical properties of the chitosan polymer such as residual ionic charges and molecular sizes. The protocol is applicable to a wide range of molecular sizes of chitosan. In addition, in one embodiment, the chitosan preparations of the present invention have the advantage of having increased stability in view of the fact that they are substantially free of chitosanase.

Chitosan is a polycationic polymer that is usually prepared commercially by limited basic hydrolysis of naturally occurring chitin, such as the exoskeleton of crustaceans and insects. Chitin is a polymer composed of N-acetyl-β-D-glucosamine (2-acetamido-2-deoxy-β-D-glucopyranose) monomeric units, whereas commercially available chitosan is usually composed of a heterogenous mixture of molecular sizes of chitin deacetylated to various extents. The basic schematic structures of chitin and chitosan are shown below.

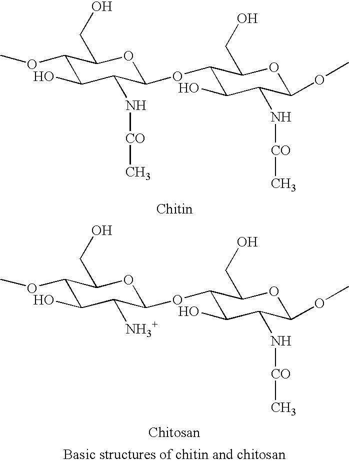

The present invention therefore broadly provides a chitosan and method of preparation thereof which overcome the defects of the preparations and methods of the prior art.

In one embodiment, the present invention concerns a method for retrieving chitosan from aqueous acidic solutions. More specifically, an object of the present invention is to provide a method for retrieving chitosan from aqueous acidic solutions by the addition of salts (salting out salts, e.g. kosmotropic salts and mixture thereof, mixture of chaotropic and kosmotropic salts, etc). In one particular embodiment, food compatible inorganic or organic salts are used to precipitate chitosan from aqueous acidic solutions.

Chitosan has a polyelectrolyte nature. Its solubility in aqueous media should thus follow rules that are similar to the empiric rules that apply to the solubility of proteins in aqueous media. These factors include pH, temperature and ionic strength of the dissolving medium. The innovative protocol described herein is based on the sensitivity of chitosan to the salting out effect caused by the addition of selected electrolytes of the Hofmeister series (Hofmeister (1888), Zur Lehre von des Wirkung des Salze. II. Naunyn-Schmiedebergs Archiv für Experimentelle Pathologie und Pharmakologie (Leipzig) 24:247-260; Kunz et al. (2004) Zur Lehre von des Wirkung des Salze. II. (About the science of the effect of salts): Franz Hofmeister's historical papers, Current Opinion in Colloid and Interface Science 9:19-37; Collins and Washabaugh (1985) The Hofmeister effect and the behaviour of water at interfaces. Quarterly Review of Biophysics 18:323-422; Cacace et al., (1997) The Hofmeister series: salt and solvent effects on interfacial phenomena. Quarterly Review of Biophysics 30:241-277), or food-compatible organic salts. The salting out effect decreases the solubility of the solute by increasing the organization of water molecules around the ions instead of the solute. This salting out effect results in the dehydration of the solute and its precipitation from solution (Collins and Washabaugh (1985), The Hofmeister effect and the behavior of water at interfaces. Quarterly Review of Biophysics 18:323-422).

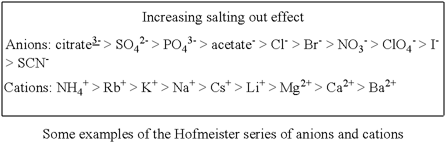

The method of the present invention comprises the addition of a salting out salt (e.g. kosmotropic salts, mixture thereof, mixtures of kosmotropic and chaotropic salts, etc) of the Hofmeister series to an aqueous acidic solution of chitosan. In one particular embodiment, a food compatible salt or a food-compatible electrolyte is added to an aqueous acidic solution of chitosan is order to precipitate it. Non-limiting examples of salting out salts that may be used in accordance with the present invention include:

Ammonium or sodium sulfate

Sodium or potassium phosphates

Sodium or potassium citrate

Sodium tartrate

Sodium malate

Sodium nitrate

Sodium lactate

Sodium malonate

Sodium succinate

Sodium acetate

Sodium propionate

Non-limiting examples of dilute aqueous acid in which chitosan is dissolved and to which the salting out salt or salts is/are added include acetic acid, lactic acid, malic acid or hydrochloric acid. Of course, other dilute aqueous acidic solutions could be used in accordance with the present invention. The effective amount of salting out salt or organic salt required to cause precipitation of chitosan depends on a number of factors including temperature, the concentration of chitosan in the aqueous acidic solution, the particular salt used, the ambient pressure, the molecular weight of the particular chitosan and the degree of deacetylation of the polymer. The present invention is not limited to the addition of only one type of salt (e.g. organic or inorganic food compatible salt). A combination of two or more (e.g. 3, 4, 5, 6 etc) salting out salts may also be used in accordance with the present invention. In addition, the combination of different salts is not limited to the combination of kosmotropic salts. Mixtures of chaotropic and kosmotropic salts may be used in accordance with the present invention as long as the global effect is the salting out of chitosan from an aqueous acidic solution.

The salted out chitosan is freed of salting out precipitating salts which can be easily monitored, for example on an industrial scale, by measuring the conductivity of the washes. Chitosan may be easily recovered from aqueous acid solution by any means known in the art including filtration, centrifugation, evaporation, spray drying or a combinations thereof.

In one embodiment, a specific chitosan polymer is considered salted out of a particular aqueous acidic solution if the specific chitosan does not dissolve to form a clear homogeneous solution when the chitosan polymer is stirred or agitated for long period of time (e.g. a week) in the aqueous salt solution at a particular temperature.

It should be understood from the foregoing that the solubility of a specific chitosan polymer in a particular aqueous acidic salt solution may be temperature dependent so that chitosan may be salted out in an aqueous solution at lower temperature but is soluble at higher temperature or vice-versa. Several examples described herein illustrate the effect of temperature on the salting out of chitosan by a series or organic and inorganic salts. Therefore one can take advantage of this particularity to retrieve chitosan from particular aqueous acidic salt solution.

The routine experimentation used to identify one or more effective salting out salts, and combination thereof (e.g. organic salt suitable for human consumption) that will precipitate a particular concentration of a particular chitosan polymer may be carried out in a number of ways. In one embodiment, the identification of the effective concentration of salt required is carried out, by measuring the percentage of precipitated chitosan in a solution by the addition of polyphosphoric acid or by a colorimetric assay according to the method of Muzzarelli (Muzzarelli (1998) Analytical Biochemistry 260:255-257). In another embodiment, the cloud point is measured to determine the effective amount of salting out salts or organic salts for precipitation of a particular chitosan. This may be done by simple visual inspection, and the solubility behavior of a particular chitosan may be correlated with the type and concentration of each salt at a given temperature.

Chitosan may be considered to be precipitated if all or if only part of the chitosan is precipitated. In one embodiment, chitosan may be considered to be precipitated if at least 90% (90, 91, 92, 93, 94, 95, 96, 97, 98, 99, 100%) of chitosan is precipitated. In another embodiment said chitosan is considered precipitated if at least 95% (95, 96, 97, 98, 99, 100%) is precipitated. In yet a further embodiment, chitosan is considered precipitated if at least 98% (98, 99, 100%) is precipitated.

The salts used in the present invention may be any salting out inorganic or organic salts. Non-limiting examples include sulfates, phosphates, citrates, nitrates, malates, tartrates, succinates, propionates, lactates and hydrogen phosphates. The counterion has a small effect and may be ammonium or any alkali or alkaline earth metal such as sodium, magnesium, calcium, potassium, lithium etc. Mixtures of inorganic or organic salts, as well as mixtures of chaotropic and kosmotropic salts, may also be used in accordance with the present invention as long as the global effect is the salting out (i.e. precipitation) of chitosan from aqueous acidic solutions.

### General Procedure for Salting Out Chitosan Using Salting Out Salts

In one embodiment, the general procedure for recovery of chitosan from aqueous solutions comprises the following. A solution containing between about 1 to 10% by weight, particularly 5% by weight, of chitosan is prepared by dissolving said chitosan in dilute aqueous acid (e.g. hydrochloric acid (about 0.2 N), acetic acid, lactic acids, malic acids (about 5 to 10%)). The precipitating salt, in a solid form, or preferably as a concentrated solution, is added preferably portion-wise, under mixing. The ratio of precipitating salt can be adjusted on a weight basis accordingly to the various examples given below and the Figures illustrating the relationships between the ratio of precipitating salts and amounts of dissolved chitosan. Furthermore, those skilled in the art will appreciate the fact that the procedure of chitosan recovery can be achieved at different temperatures as illustrated in the examples (but not restricted to) given within the embodiment of the invention. The resulting suspension of salted out chitosan is stirred for 30 minutes or, according to the amounts of chitosan to be recovered, for an extended period of time (e.g. 1 h, 1.5 h, 2 h, 3 h, 4 h, 5 h, 6 h, 8 h, 10 h, 12 h, 16 h, 24 h, 36 h, 48 h etc). The precipitate is recovered, washed and dried. Those skilled in the art will chose any one of the methods described above as best suited for the amounts of chitosan to be recovered.

### EXAMPLE 1

### Chitosan (70 kDa, 84% Deacetylated) Salting Out with Na₂SO₄

Twenty grams of chitosan 70 kDa obtained from Fluka (Sigma-Aldrich, St Louis, Mo., USA) is dissolved in 5% acetic acid (500 ml). Seventy-five grams of Na2SO4 (final concentration, 0.47 M) are added by portions, under stirring. The salted out chitosan is kept at 4° C. for about 30 minutes and then centrifuged (8000×g) for about 20 min. The supernatant does not contain any appreciable amounts of chitosan as assayed qualitatively by the addition of polyphosphoric acid as an example which is previously known in the art to form chitosan salts that are insoluble in aqueous media (Roberts (1992) Chitin chemistry, MacMillan Press Ltd, Houndmills, Hampshire, UK. page 281). Alternatively, the amount of said chitosan remaining in solution is determined quantitatively using the colorimetric assay described by Muzzarelli (Muzzarelli 1998, supra). This assay is reported to be a more sensitive and reproducible method to quantitate chitosan dissolved in an aqueous medium than other published techniques (Muzzarelli 1998, supra). The salted out chitosan is washed 3 to 5 times with water and collected by centrifugation.

### EXAMPLE 2

### Chitosan (70 kDa, 84% Deacetylated) Salting Out with Trisodium Citrate

Twenty grams of chitosan 70 kDa obtained from Fluka (Sigma-Aldrich) is dissolved in 5% acetic acid (500 ml). Eighty grams of trisodium citrate (final concentration, 0.34 M) are added by portions, under stirring. The salted out chitosan is kept at 4° C. for 30 minutes and then centrifuged (8000×g) for 20 min. The supernatant does not contain any appreciable amounts of said chitosan as assayed by the addition of polyphosphoric acid (Roberts 1992; supra) or by colorimetric assay according to the method published by Muzzarelli (Muzzarelli 1998, supra). The salted out chitosan is washed 3 to 5 times with water and collected by centrifugation.

### EXAMPLE 3

### Chitosan (30 kDa, 92% Deacetylated) Salting Out with Ammonium Sulfate

One part of 92% deacetylated chitosan of molecular weight 30 kDa determined with a triple detector array apparatus equipped with a low angle light scattering device (Viscotek Corporation, Houston, Tex., USA) obtained by enzymatic hydrolysis of commercial chitosan (Marinard Biotech Ltée, Rivière-au-Renard, Gaspésie, Quebec, Canada) is dissolved in 5% aqueous acetic acid. Four parts of a concentrated aqueous solution of ammonium sulfate are added by portions. The suspension is stirred at 4° C. for 30 to 60 minutes, depending on the amounts of chitosan to be processed. The supernatant does not contain any appreciable amounts of said chitosan as assayed by the addition of polyphosphoric acid (Roberts 1992; supra) or by calorimetric assay according to the method published by Muzzarelli (Muzzarelli 1998, supra). The salted out chitosan is washed 3 to 5 times with water and collected using suitable methods described within an embodiment of the invention.

### EXAMPLE 4

### Chitosan (30 kDa, 92% Deacetylated) Salting Out with Sodium Phosphate Monobasic

One part of 92% deacetylated chitosan of molecular weight 30 kDa determined with a triple detector array apparatus equipped with a low angle light scattering device (Viscotek Corporation) obtained by enzymatic hydrolysis of commercial chitosan (Marinard Biotech Ltée) is dissolved in 5% aqueous acetic acid. Four parts of a concentrated aqueous solution of sodium phosphate monobasic are added by portions. The suspension is stirred at room temperature for 30 to 60 minutes, depending on the amounts of chitosan to be processed. The supernatant does not contain any appreciable amounts of said chitosan as assayed by the addition of polyphosphoric acid (Roberts 1992; supra) or by colorimetric assay according to the method published by Muzzarelli (Muzzarelli 1998, supra). The salted out chitosan is washed with water and collected using suitable methods described within an embodiment of the invention.

### EXAMPLE 5

### Chitosan (240 kDa, 92% Deacetylated) Salting Out with Sodium Sulfate

One part of 92% deacetylated chitosan 240 kDa obtained from Vanson HaloSource (Redmond, Wash., USA) is dissolved in 10% aqueous acetic acid. Four parts of a concentrated aqueous solution of sodium sulfate are added by portions. The suspension is stirred at room temperature for 30 to 60 minutes, depending on the amounts of chitosan to be processed. The supernatant does not contain any appreciable amounts of said chitosan as assayed by the addition of polyphosphoric acid (Roberts 1992; supra) or by colorimetric assay according to the method published by Muzzarelli (Muzzarelli 1998, supra). The salted out chitosan is washed with water and collected using suitable methods described within an embodiment of the invention.

### EXAMPLE 6

### High Molecular Weight Chitosan (300 cps, 92% Deacetylated) Salting Out with Ammonium Sulfate

One part of 92% deacetylated high molecular weight chitosan (300 cps) obtained from Vanson HaloSource (Redmond, Wash., USA) is dissolved in 10% aqueous acetic acid. Four parts of a concentrated aqueous solution of ammonium sulfate are added by portions. The suspension is stirred at room temperature for 30 to 60 minutes, depending on the amounts of chitosan to be processed. The supernatant does not contain any appreciable amounts of chitosan as assayed by the addition of polyphosphoric acid (Roberts 1992; supra) or by colorimetric assay according to the method published by Muzzarelli (Muzzarelli 1998, supra). The salted out chitosan is washed with water and collected using suitable methods described within an embodiment of the invention.

### EXAMPLE 7

### Efficiency of Trisodium Citrate to Salt Out Chitosan (92% Deacetylated) of Various Molecular Sizes at 4° C.

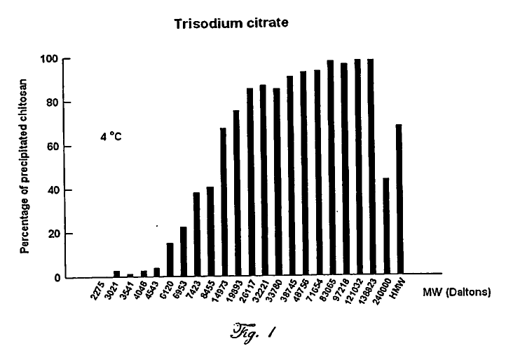

FIG. 1 illustrates the efficiency of trisodium citrate to salt out 92% deacetylated chitosan of various molecular sizes determined with a triple detector array apparatus equipped with a low angle light scattering device (Viscotek Corporation) from enzymatic hydrolysates of a 240 kDa chitosan (Vanson HaloSource). Samples of the said chitosan hydrolysates dissolved in 5% aqueous acetic acid are cooled to 4° C. Five parts of an aqueous solution of trisodium citrate are added at 4° C. and the suspension is stirred for 30 to 60 minutes at 4° C., depending on the amounts of chitosan to be processed. The chitosans are separated from the soluble phase and the amount of chitosan remaining in the soluble phase is determined using a colorimetric assay according to the method published by Muzzarelli (Muzzarelli 1998, supra). FIG. 1 also illustrates the efficiency of trisodium citrate to salt out unhydrolyzed chitosans of 240 kDa and high molecular weight (HMW). It is of importance to note for those skilled in the art, that the activity of chitosanase remains in the soluble phase of the hydrolysates.

### EXAMPLE 8

### Efficiency of Trisodium Citrate to Salt Out Chitosan (92% Deacetylated) of Various Molecular Sizes at Room Temperature

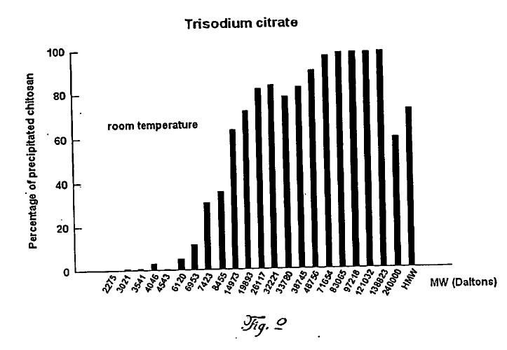

FIG. 2 illustrates the efficiency of trisodium citrate to salt out 92% deacetylated chitosan of various molecular sizes determined with a triple detector array apparatus equipped with a low angle light scattering device (Viscotek Corporation) from enzymatic hydrolysates of a 240 kDa chitosan (Vanson HaloSource). Samples of the said chitosans dissolved in 5% aqueous acetic acid are kept at room temperature. Five parts of an aqueous solution of trisodium citrate are then added at room temperature and the solution is stirred for 30 to 60 minutes at room temperature, depending on the amounts of chitosan to be processed. The chitosans are separated from the soluble phase and the amount of chitosan remaining in the soluble phase is determined using a colorimetric assay according to the method published by Muzzarelli (Muzzarelli 1998, supra). FIG. 2 also illustrates the efficiency of trisodium citrate to salt out unhydrolyzed chitosans of 240 kDa and high molecular weight (HMW). It is of importance to note for those skilled in the art, that the activity of chitosanase remains in the soluble phase.

### EXAMPLE 9

### Efficiency of Ammonium Sulfate to Salt Out Chitosan (92% Deacetylated) of Various Molecular Sizes at 4° C.

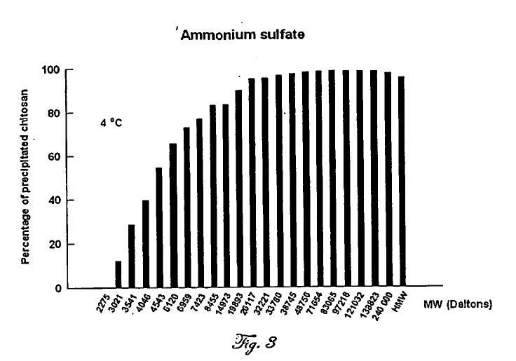

FIG. 3 illustrates the efficiency of ammonium sulfate to salt out 92% deacetylated chitosan of various molecular sizes determined with a triple detector array apparatus equipped with a low angle light scattering device (Viscotek Corporation) from enzymatic hydrolysates of a 240 kDa chitosan (Vanson HaloSource). Samples of the said chitosan hydrolysates dissolved in 5% aqueous acetic acid are cooled to 4° C. Five parts of an aqueous solution of ammonium sulfate cooled to 4° C. are added by portions and the suspension is stirred for 30 to 60 minutes at 4° C., depending on the amounts of chitosan to be processed. The chitosans are separated from the soluble phase and the amount of chitosan remaining in the soluble phase is determined using a colorimetric assay according to the method published by Muzzarelli (Muzzarelli 1998, supra). FIG. 3 also illustrates the efficiency of ammonium sulfate to salt out unhydrolyzed chitosans of 240 kDa and high molecular weight (HMW).

### EXAMPLE 10

### Efficiency of Ammonium Sulfate to Salt Out Chitosan (92% Deacetylated) of Various Molecular Sizes at Room Temperature

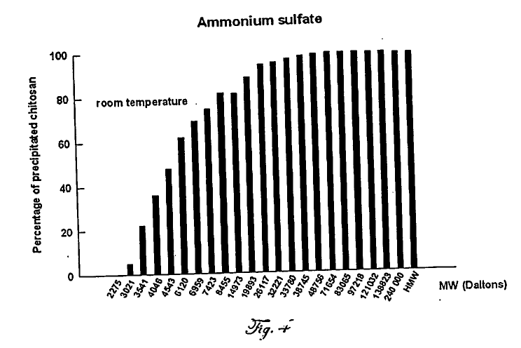

FIG. 4 illustrates the efficiency of ammonium sulfate to salt out 92% deacetylated chitosan of various molecular sizes determined with a triple detector array apparatus equipped with a low angle light scattering device (Viscotek Corporation) from enzymatic hydrolysates of a 240 kDa chitosan (Vanson HaloSource). Samples of the said chitosans dissolved in 5% aqueous acetic acid are kept at room temperature. Five parts of an aqueous solution of ammonium sulfate are added by portions at room temperature and the suspension is stirred for 30 to 60 minutes at room temperature, depending on the amounts of chitosan to be processed. The chitosans are separated from the soluble phase and the amount of chitosan remaining in the soluble phase is determined using a colorimetric assay according to the method published by Muzzarelli (Muzzarelli 1998, supra). FIG. 4 also illustrates the efficiency of ammonium sulfate to salt out unhydrolyzed chitosans of 240 kDa and high molecular weight (HMW).

### EXAMPLE 11

### Efficiency of Sodium Sulfate to Salt Out Chitosan (30 kDa, 92% Deacetylated) at 4° C., Room Temperature and 50° C.

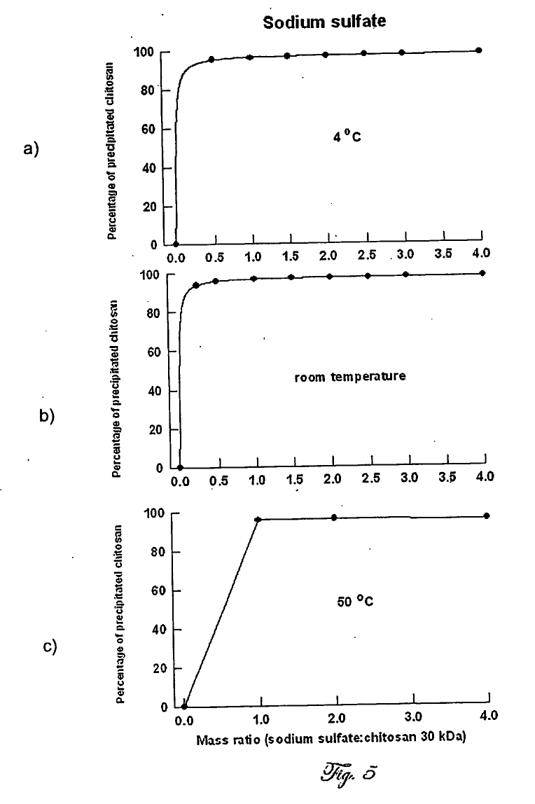

Increasing weight amounts of solid sodium sulfate or, preferably, a concentrated solution of sodium sulfate are added by portions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 5. Suspended chitosan is separated from the soluble phase and the amount of chitosan remaining in the soluble phase is determined using a colorimetric assay according to the method published by Muzzarelli (Muzzarelli 1998, supra).

### EXAMPLE 12

### Efficiency of Trisodium Citrate to Salt Out Chitosan (30 kDa, 92% Deacetylated) at 4° C., Room Temperature and 50° C.

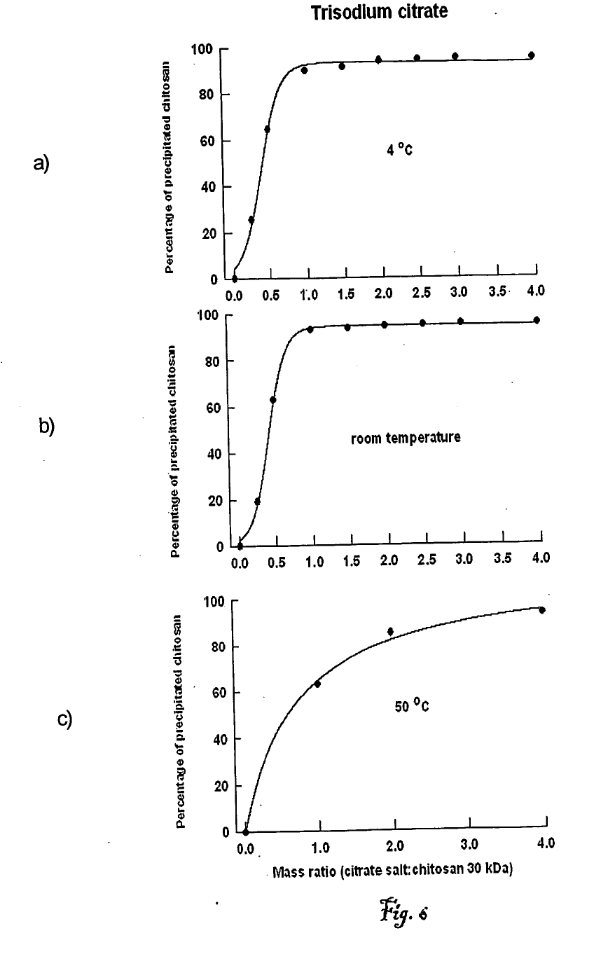

Increasing weight amounts of solid trisodium citrate or, preferably, a concentrated solution of trisodium citrate are added by portions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 6. Suspended chitosan is separated from the soluble phase and the amount of chitosan in the soluble phase is determined using a colorimetric assay according to the method published by Muzzarelli (Muzzarelli 1998, supra).

### EXAMPLE 13

### Efficiency of Ammonium Sulfate to Salt Out Chitosan (30 kDa, 92% Deacetylated) at 4° C., Room Temperature and 50° C.

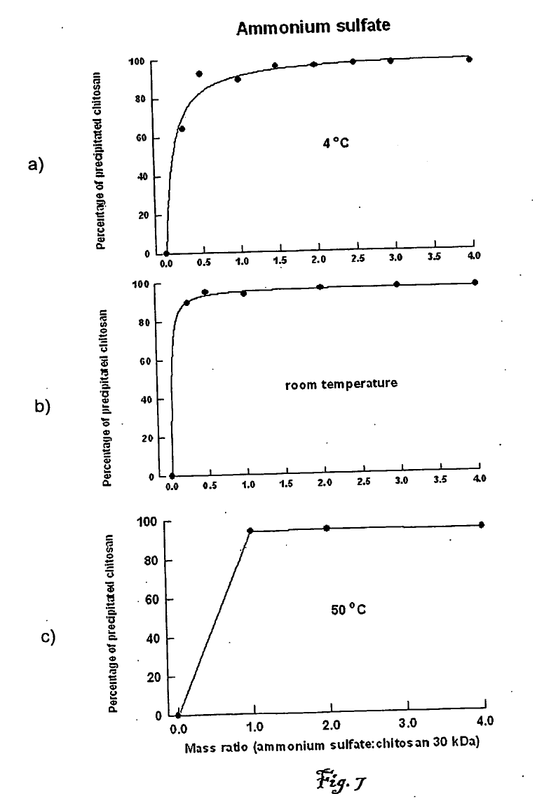

Increasing weight amounts of solid ammonium sulfate or, preferably, a concentrated solution of ammonium sulfate are added by portions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 7. Suspended chitosan is separated from the soluble phase and the amount of chitosan in the soluble phase is determined using a colorimetric assay according to the method published by Muzzarelli (Muzzarelli 1998, supra).

### EXAMPLE 14

### Efficiency of Disodium Tartrate to Salt Out Chitosan (30 kDa, 92% Deacetylated) at 4° C., Room Temperature and 50° C.

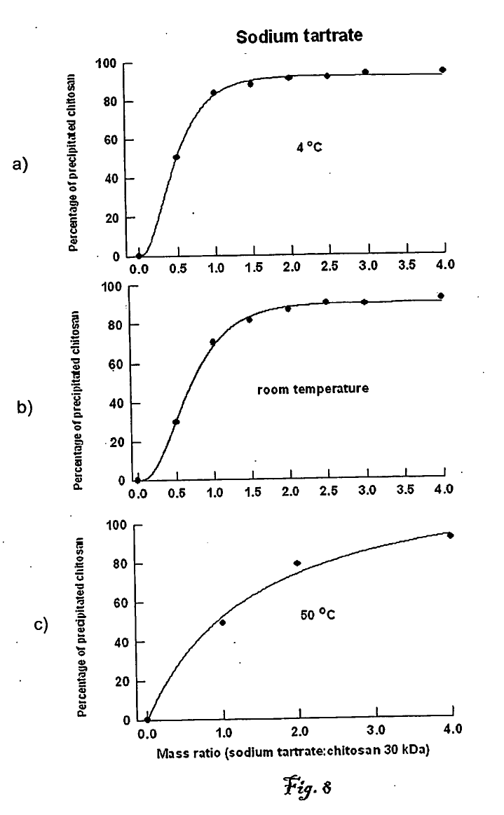

Increasing weight amounts of solid disodium tartrate or, preferably, a concentrated solution of disodium tartrate are added by portions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 8. Suspended chitosan is separated from the soluble phase and the amount of chitosan in the soluble phase is determined using a colorimetric assay according to the method published by Muzzarelli (Muzzarelli 1998, supra).

### EXAMPLE 15

### Efficiency of Sodium Phosphate Monobasic to Salt Out Chitosan (30 kDa, 92% Deacetylated) at 4° C., and Room Temperature and 50° C.

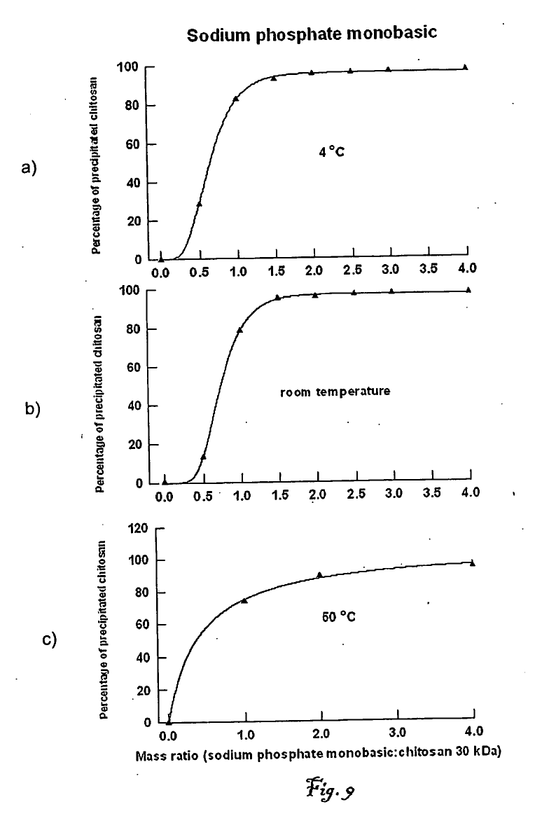

Increasing weight amounts of solid sodium phosphate monobasic or, preferably, a concentrated solution of sodium phosphate monobasic are added by portions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 9. Suspended chitosan is separated from the soluble phase and the amount of chitosan in the soluble phase is determined using a colorimetric assay according to the method published by Muzzarelli (Muzzarelli 1998, supra).

### EXAMPLE 16

### Efficiency of Disodium Malate to Salt Out Chitosan (30 kDa, 92% Deacetylated) at 4° C., Room Temperature and 50° C.

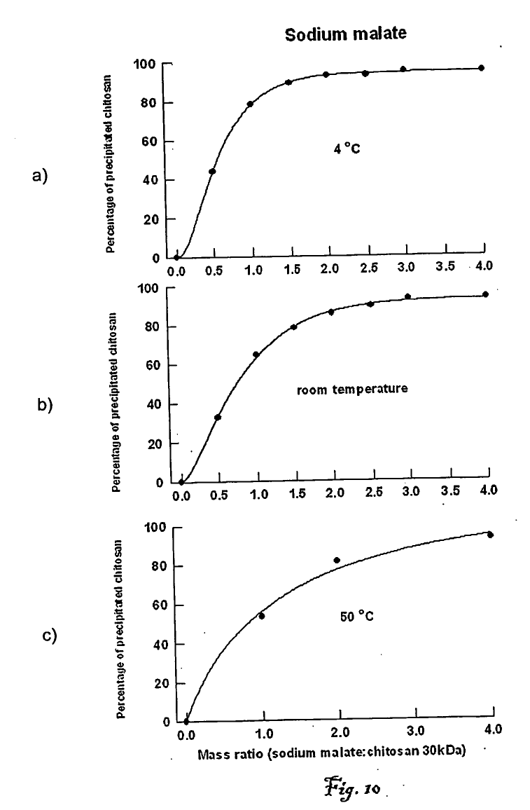

Increasing weight amounts of solid disodium malate or, preferably, a concentrated solution of disodium malate are added by portions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 10. Suspended chitosan is separated from the soluble phase and the amount of chitosan in the soluble phase is determined using a colorimetric assay according to the method published by Muzzarelli (Muzzarelli 1998, supra).

### EXAMPLE 17

### Efficiency of Sodium Nitrate to Salt Out Chitosan (30 kDa, 92% Deacetylated) at 4° C., Room Temperature and 50° C.

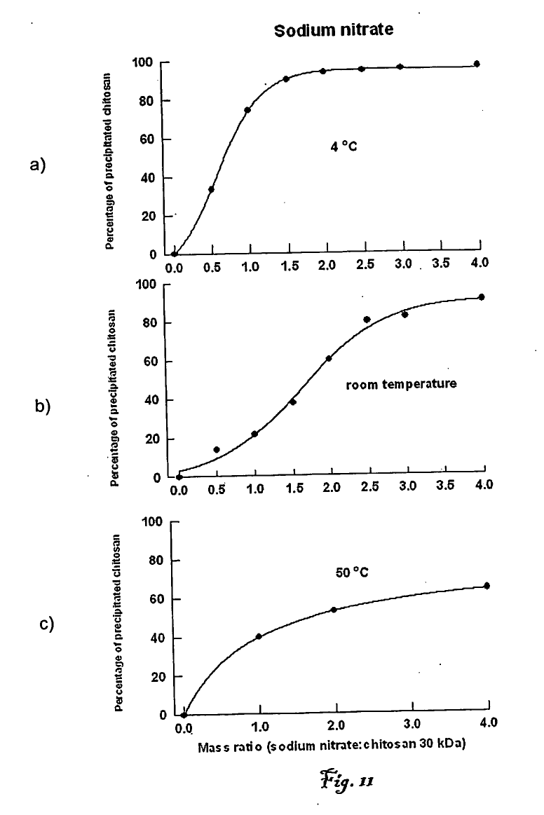

Increasing weight amounts of solid sodium nitrate or, preferably, a concentrated solution of sodium nitrate are added by portions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 11. Suspended chitosan is separated from the soluble phase and the amount of chitosan in the soluble phase is determined using a calorimetric assay according to the method published by Muzzarelli (Muzzarelli 1998, supra).

### EXAMPLE 18

### Efficiency of Sodium Phosphate Dibasic to Salt Out Chitosan (30 kDa, 92% Deacetylated) at 4° C., Room Temperature and 50° C.

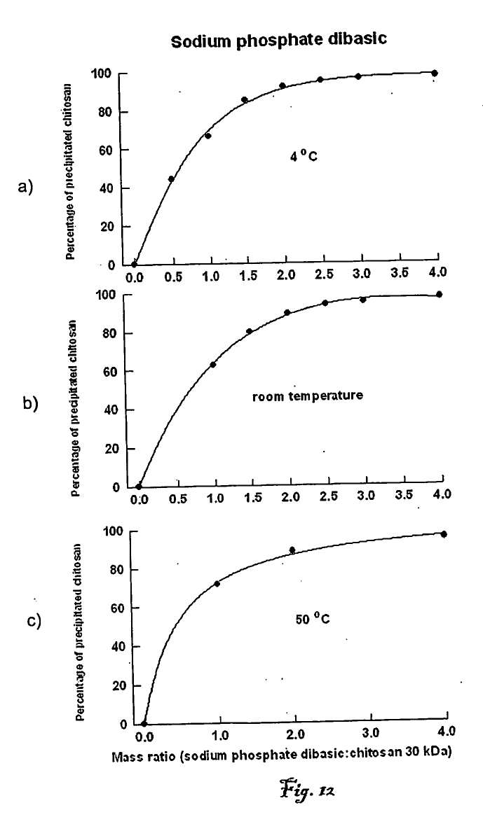

Increasing weight amounts of solid sodium phosphate dibasic or, preferably, a concentrated solution of sodium phosphate dibasic are added by portions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 12. Suspended chitosan is separated from the soluble phase and the amount of chitosan in the soluble phase is determined using a calorimetric assay according to the method published by Muzzarelli (Muzzarelli 1998, supra).

### EXAMPLE 19

### Efficiency of Disodium Succinate to Salt Out Chitosan (30 kDa, 92% Deacetylated) at 4° C., Room Temperature and 50° C.

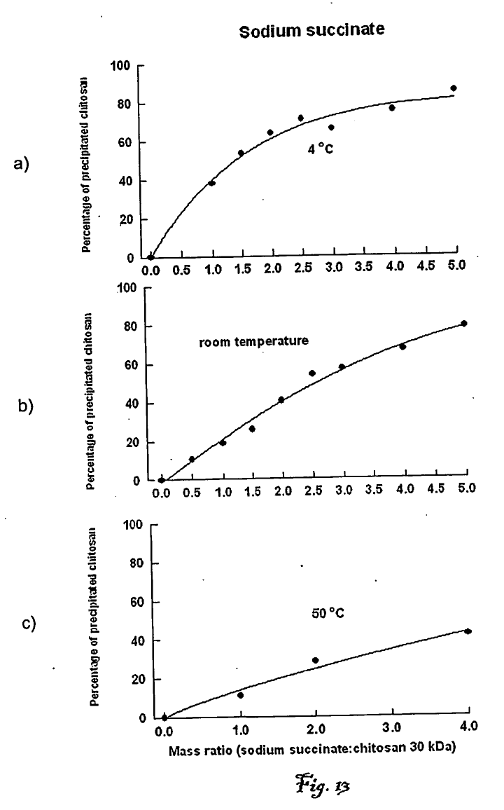

Increasing weight amounts of solid disodium succinate or, preferably, a concentrated solution of disodium succinate are added to triplicates of chitosan solutions to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 13. Suspended chitosan is separated from the soluble phase and the amount of chitosan in the soluble phase is determined using a colorimetric assay according to the method published by Muzzarelli (Muzzarelli 1998, supra).

### EXAMPLE 20

### Efficiency of Sodium Acetate to Salt Out Chitosan (30 kDa, 92% Deacetylated) at 4° C., Room Temperature and 50° C.

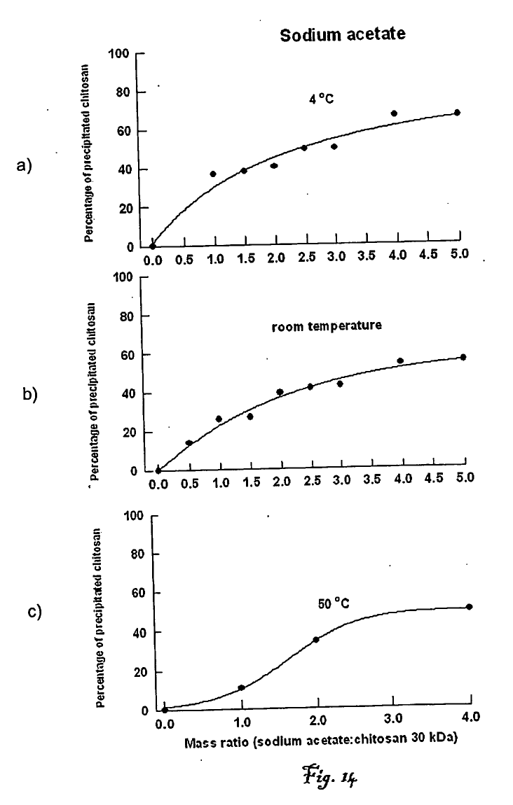

Increasing weight amounts of solid sodium acetate or, preferably, a concentrated solution of sodium acetate are added to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 14. Suspended chitosan is separated from the soluble phase and the amount of chitosan in the soluble phase is determined using a colorimetric assay according to the method published by Muzzarelli (Muzzarelli 1998, supra).

### EXAMPLE 21

### Efficiency of Disodium Malonate to Salt Out Chitosan (30 kDa, 92% Deacetylated) at 4° C. and Room Temperature

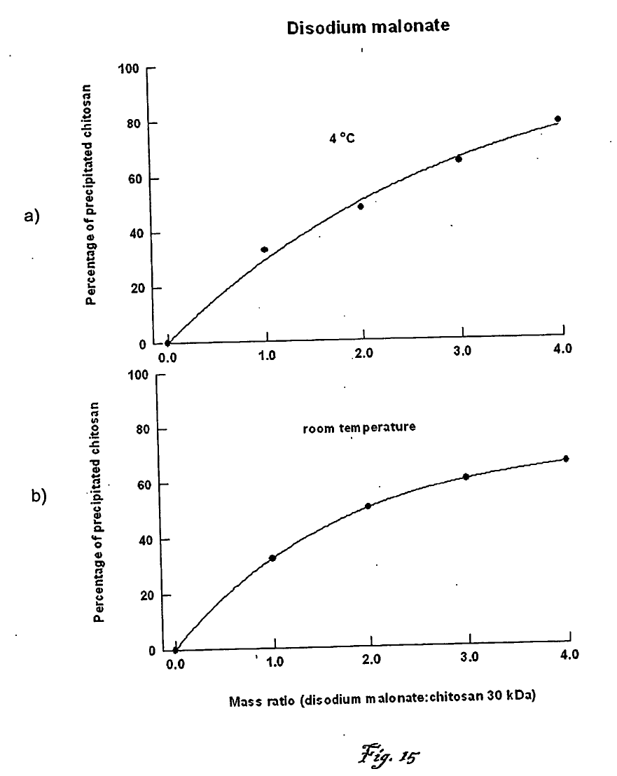

Increasing weight amounts of solid disodium malonate or, preferably, a concentrated solution of disodium malonate are added to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 15. Suspended chitosan is separated from the soluble phase and the amount of chitosan in the soluble phase is determined using a calorimetric assay according to the method published by Muzzarelli (Muzzarelli 1998, supra).

### EXAMPLE 22

### Efficiency of Sodium Lactate to Salt Out Chitosan (30 kDa, 92% Deacetylated) at 4° C., Room Temperature and 50° C.

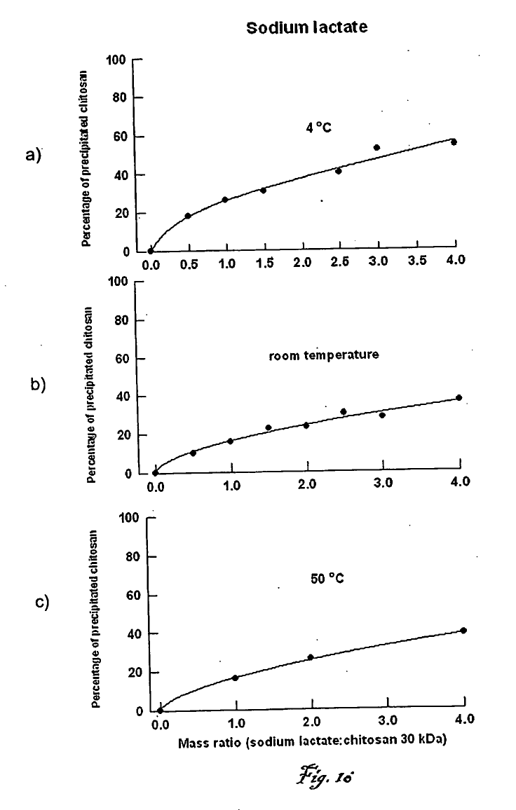

Increasing weight amounts of solid sodium lactate or, preferably, a concentrated solution of sodium lactate are added to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 16. Suspended chitosan is separated from the soluble phase and the amount of chitosan remaining in the soluble phase is determined using a calorimetric assay according to the method published by Muzzarelli (Muzzarelli 1998, supra).

### EXAMPLE 23

### Efficiency of Sodium Propionate to Salt Out Chitosan (30 kDa, 92% Deacetylated) at 4° C. and Room Temperature

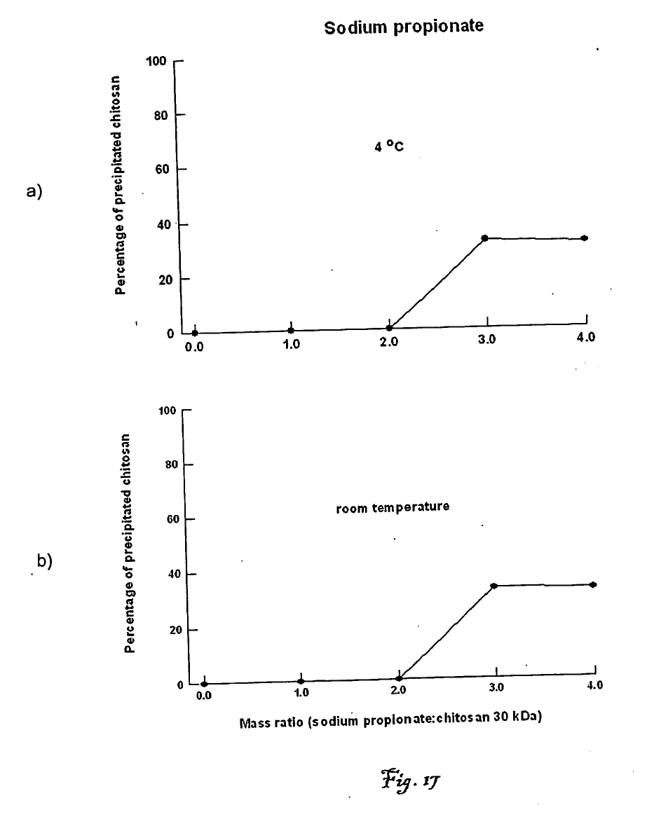

Increasing weight amounts of sodium propionate or, preferably, a concentrated solution of sodium propionate are added to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 17. Suspended chitosan is separated from the soluble phase and the amount of chitosan remaining in the soluble phase is determined using a colorimetric assay according to the method published by Muzzarelli (Muzzarelli 1998, supra).

### EXAMPLE 24

### Comparative Efficiencies of Salting Out Inorganic and Organic Salts Used at a 1:1 and 4:1 Ratio Respective to Dissolved Chitosan to Salt Out Chitosan (30 kDa, 92% Deacetylated) at 4° C., Room Temperature and 50° C.

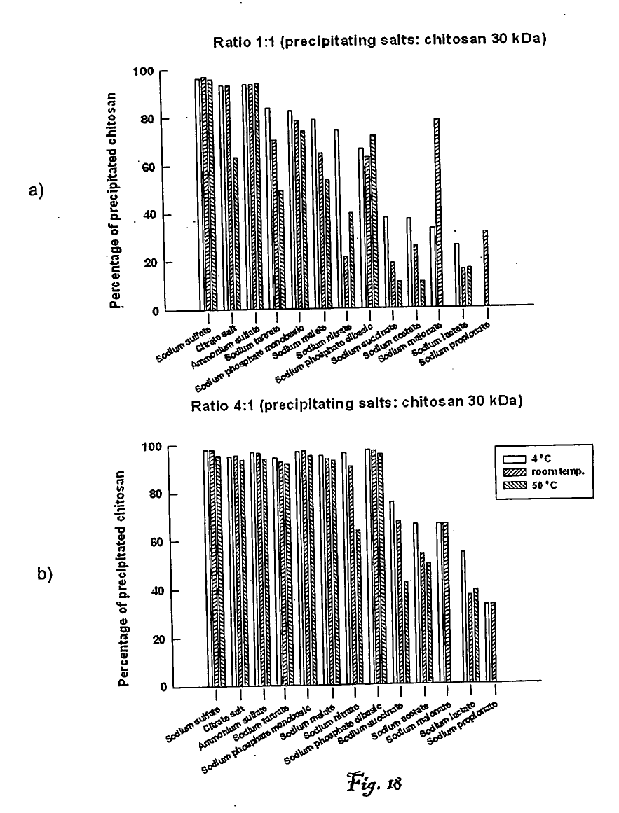

Mass ratio of 1:1 and 4:1 relative to said chitosans of inorganic or organic salting out salts are added to one part of 92% deacetylated chitosan of molecular weight 30 kDa (determined with a triple detector array apparatus equipped with a low angle light scattering device, Viscotek Corporation) obtained by enzymatic hydrolysis of commercial chitosan (Marinard Biotech Ltée) dissolved in 5% aqueous acetic acid. The suspensions are stirred for 30 to 60 minutes, depending on the amounts of chitosan to be processed, at the temperatures illustrated in FIG. 18. Suspended chitosans are separated from the soluble phase and the amount of chitosan remaining in the soluble phase is determined using a calorimetric assay according to the method published by Muzzarelli (Muzzarelli 1998, supra).

### EXAMPLE 25

### Efficiency of Ammonium Sulfate to Salt Out Chitosan (240 kDa, 92% Deacetylated) at 4° C. and Room Temperature

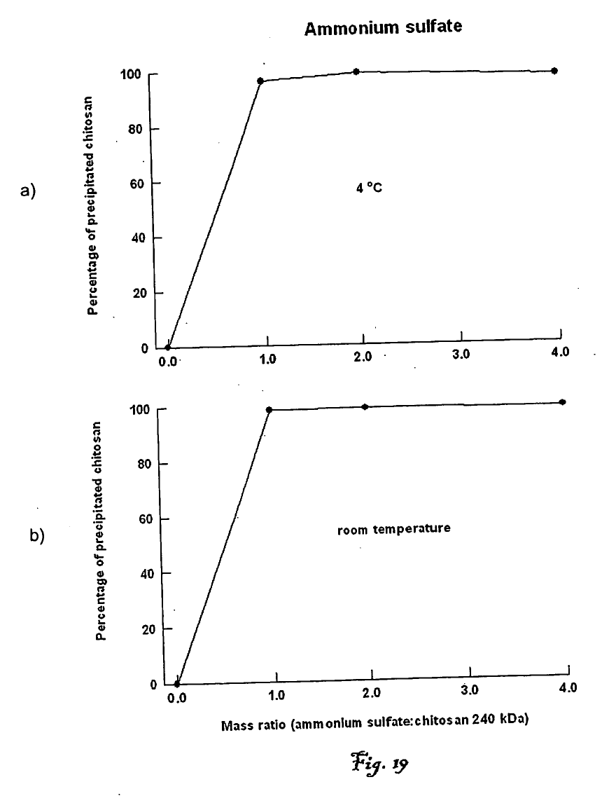

Increasing weight amounts of solid ammonium sulfate or, preferably, a concentrated solution of ammonium sulfate are added to one part of 92% deacetylated chitosan of molecular weight 240 kDa (Vanson HaloSource) dissolved in 5% aqueous acetic acid. The suspensions are stirred for 30 to 60 minutes, depending on the amounts of chitosan to be processed, at the temperatures illustrated in FIG. 19. Suspended chitosan is separated from the soluble phase and the amount of remaining chitosan in the soluble phase is determined using a calorimetric assay according to the method published by Muzzarelli (Muzzarelli 1998, supra).

### EXAMPLE 26

### Efficiency of Sodium Sulfate to Salt Out Chitosan (240 kDa, 92% Deacetylated) at 4° C. and Room Temperature

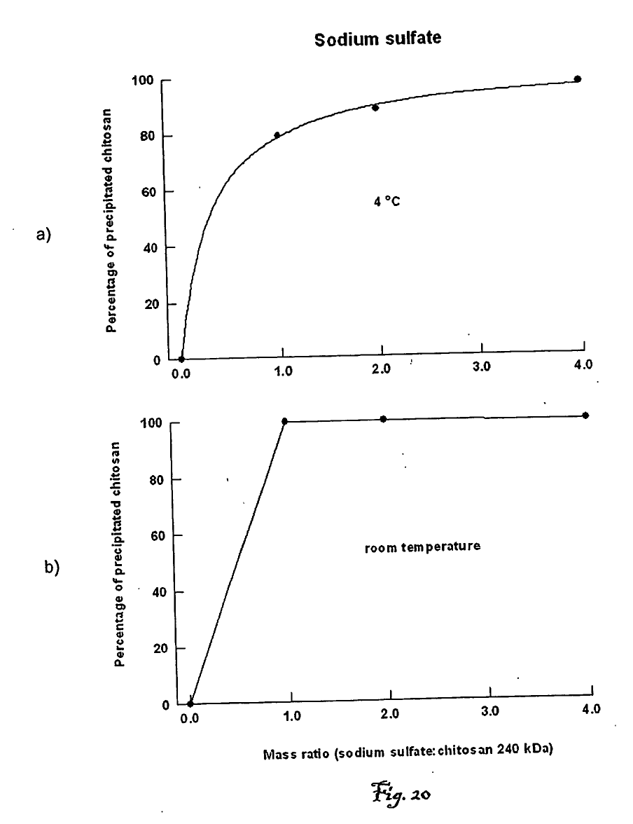

Increasing weight amounts of solid sodium sulfate or, preferably, a concentrated solution of sodium sulfate are added to one part of 92% deacetylated chitosan of molecular weight 240 kDa (Vanson HaloSource) dissolved in 5% aqueous acetic acid. The suspensions are stirred for 30 to 60 minutes, depending on the amounts of chitosan to be processed, at the temperatures illustrated in FIG. 20. Suspended chitosan is separated from the soluble phase and the amount of chitosan remaining in the soluble phase is determined using a colorimetric assay according to the method published by Muzzarelli (Muzzarelli 1998, supra).

### EXAMPLE 27

### Efficiency of Trisodium Citrate to Salt Out Chitosan (240 kDa, 92% Deacetylated) at 4° C. and Room Temperature

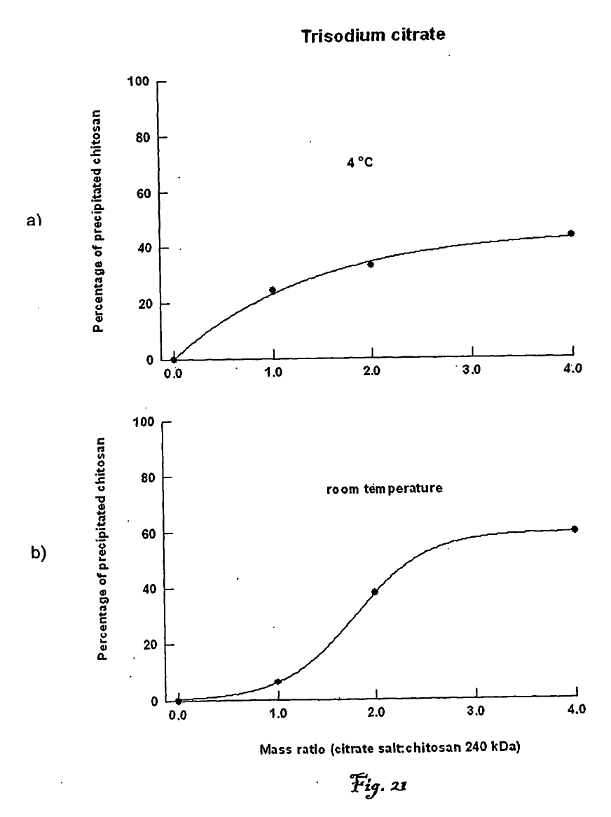

Increasing weight amounts of solid trisodium citrate or, preferably, a concentrated solution of trisodium citrate are added to one part of 92% deacetylated chitosan of molecular weight 240 kDa (Vanson HaloSource) dissolved in 5% aqueous acetic acid. The suspensions are stirred for 30 to 60 minutes, depending on the amounts of chitosan to be processed, at the temperatures illustrated in FIG. 21. Suspended chitosan is separated from the soluble phase and the amount of chitosan remaining in the soluble phase is determined using a calorimetric assay according to the method published by Muzzarelli (Muzzarelli 1998, supra).

### EXAMPLE 28

### Efficiency of Sodium Phosphate Monobasic to Salt Out Chitosan (240 kDa, 92% Deacetylated) at 4° C. and Room Temperature

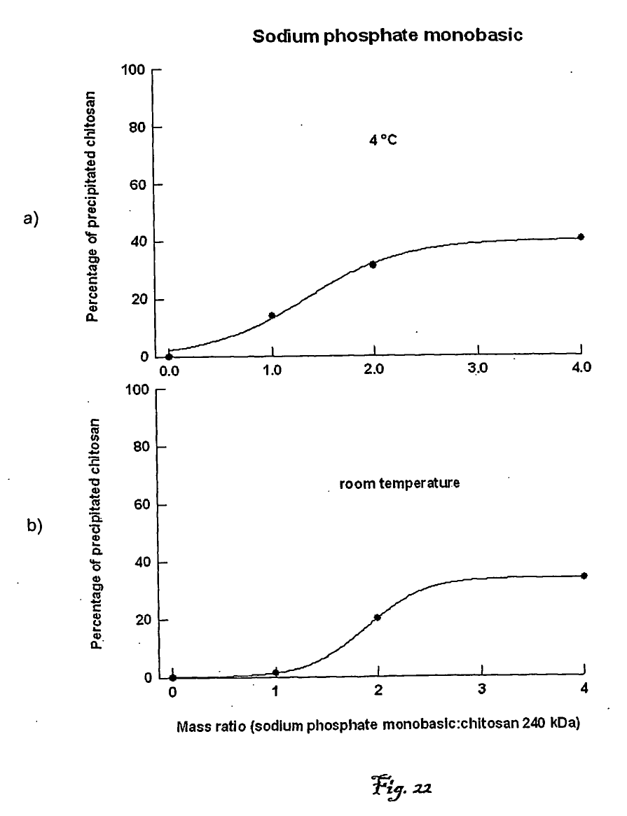

Increasing weight amounts of solid sodium phosphate monobasic or, preferably, a concentrated solution of sodium phosphate monobasic are added to one part of 92% deacetylated chitosan of molecular weight 240 kDa (Vanson HaloSource) dissolved in 5% aqueous acetic acid. The suspensions are stirred for 30 to 60 minutes, depending on the amounts of chitosan to be processed, at the temperatures illustrated in FIG. 22. Suspended chitosan is separated from the soluble phase and the amount of chitosan remaining in the soluble phase is determined using a calorimetric assay according to the method published by Muzzarelli (Muzzarelli 1998, supra).

### EXAMPLE 29

### Comparative Efficiencies of Salting Out Inorganic and Organic Salts Used at a 1:1 and 4:1 Ratio Relative to Dissolved Chitosan to Salt Out Chitosan (240 kDa, 92% Deacetylated) at 4° C. and Room Temperature

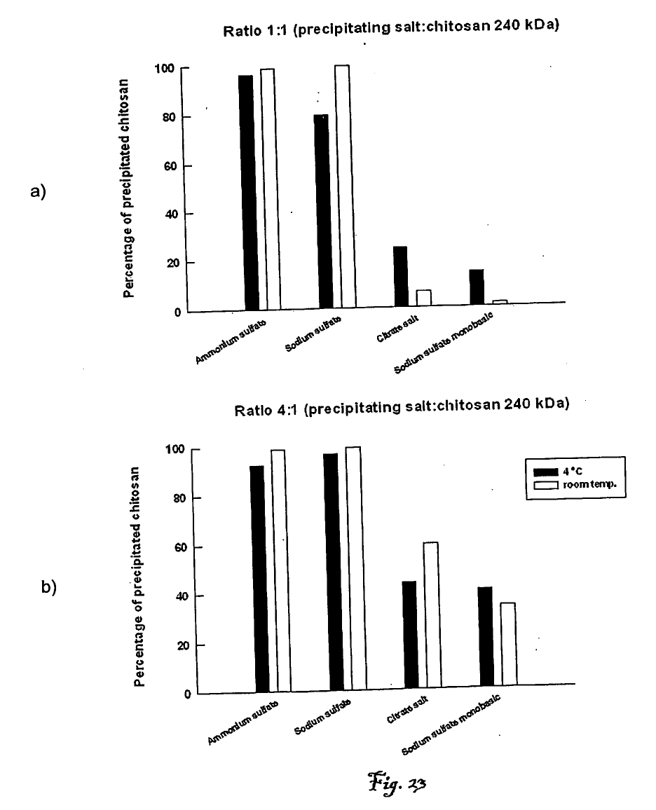

Mass ratio of 1:1 and 4:1 relative to said dissolved chitosans of inorganic or organic salting out salts are added to one part of 92% deacetylated chitosan of molecular weight 240 kDa (Vanson HaloSource) dissolved in 5% aqueous acetic acid. The suspensions are stirred for 30 to 60 minutes, depending on the amounts of chitosan to be processed, at the temperatures illustrated in FIG. 23. Suspended chitosan is separated from the soluble phase and the amount of chitosan remaining in the soluble phase is determined using a calorimetric assay according to the method published by Muzzarelli (Muzzarelli 1998, supra).

### EXAMPLE 30

### Efficiency of Ammonium Sulfate to Salt Out a High Molecular Weight (HMW) Chitosan (300 CPS, 92% Deacetylated) at 4OC and Room Temperature

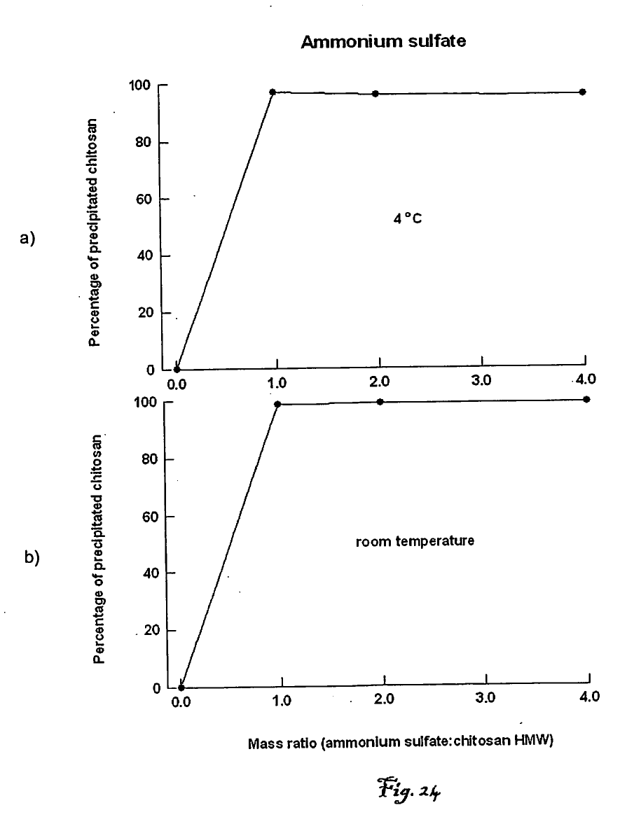

Increasing weight amounts of solid ammonium sulfate or preferably, a concentrated solution of ammonium sulfate are added to one part of 92% deacetylated chitosan of high molecular weight (Vanson HaloSource) dissolved in 5% aqueous acetic acid. The suspensions are stirred for 30 to 60 minutes, depending on the amounts of chitosan to be processed, at the temperatures illustrated in FIG. 24. Suspended chitosan is separated from the soluble phase and the amount of chitosan remaining in the soluble phase is determined using a calorimetric assay according to the method published by Muzzarelli (Muzzarelli 1998, supra).

### EXAMPLE 31

### Efficiency of Sodium Sulfate to Salt Out a High Molecular Weight (HMW) Chitosan (300 CPS, 92% Deacetylated) at 4° C. and Room Temperature

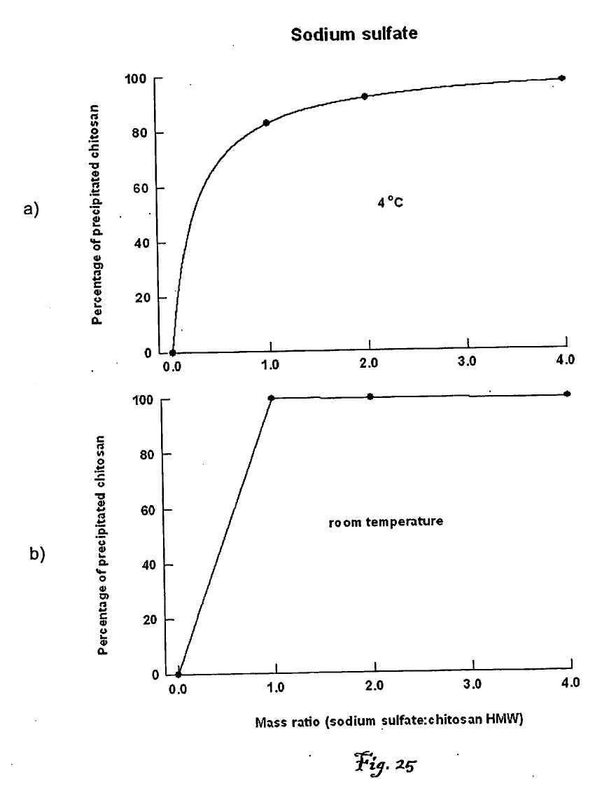

Increasing weight amounts of solid sodium sulfate or, preferably, a concentrated solution of sodium sulfate are added to one part of 92% deacetylated chitosan of a high molecular weight chitosan (Vanson HaloSource) dissolved in 5% aqueous acetic acid. The suspensions are stirred for 30 to 60 minutes, depending on the amounts of chitosan to be processed, at the temperatures illustrated in FIG. 25. Suspended chitosan is separated from the soluble phase and the amount of chitosan remaining in the soluble phase is determined using a calorimetric assay according to the method published by Muzzarelli (Muzzarelli 1998, supra).

### EXAMPLE 32

### Efficiency of Sodium Phosphate Monobasic to Salt Out a High Molecular Weight (HMW) Chitosan (300 CPS, 92% Deacetylated) at 4° C. and Room Temperature

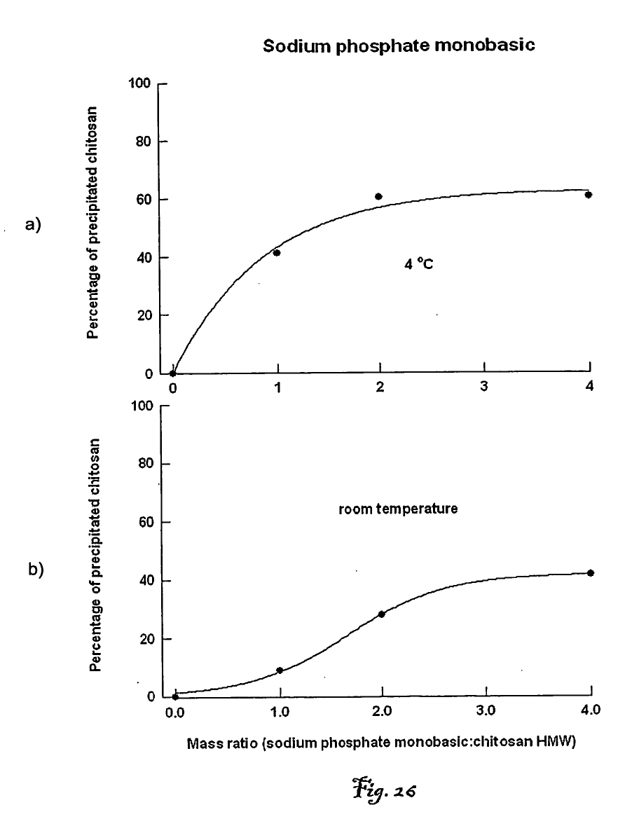

Increasing weight amounts of solid sodium phosphate monobasic or, preferably, a concentrated solution of sodium phosphate monobasic are added to one part of 92% deacetylated chitosan of a high molecular weight chitosan (Vanson HaloSource) dissolved in 5% aqueous acetic acid. The suspensions are stirred for 30 to 60 minutes, depending on the amounts of chitosan to be processed, at the temperatures illustrated in FIG. 26. Suspended chitosan is separated from the soluble phase and the amount of chitosan remaining in the soluble phase is determined using a calorimetric assay according to the method published by Muzzarelli (Muzzarelli 1998, supra).

### EXAMPLE 33

### Efficiency of Trisodium Citrate to Salt Out a High Molecular Weight (HMW) Chitosan (300 CPS, 92% Deacetylated) at 4° C. and Room Temperature

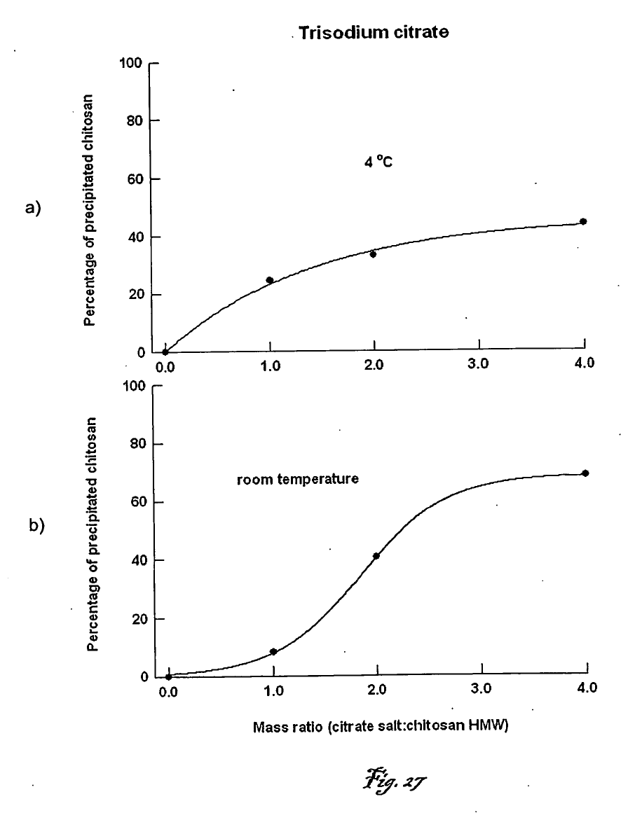

Increasing weight amounts of solid trisodium citrate or, preferably, a concentrated solution of trisodium citrate are added to one part of 92% deacetylated chitosan of a high molecular weight chitosan (Vanson HaloSource) dissolved in 5% aqueous acetic acid. The suspensions are stirred for 30 to 60 minutes, depending on the amounts of chitosan to be processed, at the temperatures illustrated in FIG. 27. Suspended chitosan is separated from the soluble phase and the amount of chitosan remaining in the soluble phase is determined using a colorimetric assay according to the method published by Muzzarelli (Muzzarelli 1998, supra).

### EXAMPLE 34

### Comparative Efficiencies of Salting Out Inorganic and Organic Salts Used at a 1:1 and 4:1 Ratio Relative to Dissolved Chitosan to Salt Out Chitosan (300 CPS, 92% Deacetylated) at 4° C. and Room Temperature

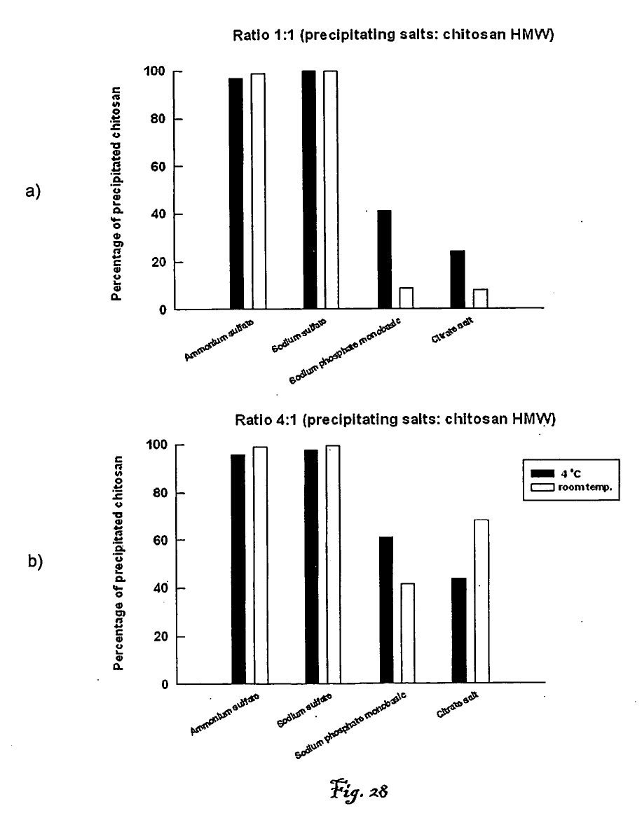

Mass ratio of 1:1 and 4:1 relative to said chitosan of inorganic or organic salting out salts are added to one part of 92% deacetylated chitosan of a high molecular weight (Vanson HaloSource) dissolved in 5% aqueous acetic acid. The suspensions are stirred for 30 to 60 minutes, depending on the amounts of chitosan to be processed, at the temperatures illustrated in FIG. 28. Suspended chitosan is separated from the soluble phase and the amount of chitosan remaining in the soluble phase is determined using a colorimetric assay according to the method published by Muzzarelli (Muzzarelli 1998, supra).

### EXAMPLE 35

### Solubility of Chitosans Retrieved from Aqueous Solutions by Salting Out with Organic or Inorganic Salting Out Salts

### The Solubility is Qualitatively Assessed in Dilute Aqueous Hydrochloric Acid or Dilute Aqueous Acetic Acid

Table 1 illustrates examples of the solubility of chitosans of various molecular weights that were salted out (i.e. precipitated) with a series of salting out salts described within an embodiment of the present invention. The solubility of samples in dilute (5%) aqueous acetic acid and in aqueous hydrochloric acid used at a concentration similar to the concentration found in the stomach (0.2 N) is qualitatively shown.

TABLE 1
Solubility of chitosan precipitates in dilute hydrochloric acid or dilute acetic acid

| | Solubility | | | | | |
|---|---|---|---|---|---|---|
| | Chitosan | | | | | |
| | 30 kDa | | 240 kDa | | HMW | |
| Salt used for | HCl | Acetic | HCl | Acetic acid | HCl | Acetic acid |
| precipitation | (0.2N) | acid (5%) | (0.2N) | (5%) | (0.2N) | (5%) |
| Ammonium | ns | ns | ++ | ns | +++ | ns |
| sulfate | | | | | | |
| Sodium | ++ | ns | ++++ | ++++ | ns | ns |
| phosphate | | | | | | |
| monobasic | | | | | | |
| Trisodium citrate | +++ | ++ | ++ | ++ | +++ | +++ |
| Sodium sulfate | ns | ns | +++ | ns | ns | ns |
| Sodium | ++ | ns | ++++ | ++++ | ++++ | ++++ |
| phosphate | | | | | | |
| dibasic | | | | | | |
| Sodium nitrate | ++++ | ++++ | ++++ | ++++ | ++++ | ++++ |
| Disodium | +++ | +++ | +++ | ++ | +++ | ++ |
| tartrate | | | | | | |
| Disodium malate | + | + | ++++ | ++++ | ++++ | ++++ |
| Disodium | +++ | +++ | nd | nd | nd | nd |
| malonate | | | | | | |

Legends
++++, the pellet is readily soluble
+++, the pellet dissolves within 1 min
++, the pellet dissolves within 1-5 min
+, the pellet dissolves within 5-10 min
ns, the pellet does not dissolve after 15 min
nd, not determined

Chitosan can also be retrieved from dilute aqueous acetic acid solutions by the addition of a combination of salting out salts (e.g. kosmotropic salts, mixture thereof, mixture of kosmotropic and chaotropic salts, etc) such as trisodium citrate and ammonium sulfate or sodium sulfate or sodium phosphate monobasic which are given as examples.

In summary, based on the disclosure herein, those skilled in the art can purify chitosan from aqueous acidic solutions by adding salting out salts (e.g. kosmotropic salts, mixture thereof or combination of chaotropic and kosmotropic salts). Chitosan purified by means of the present invention prevent at least some modifications of the physical properties of the chitosan polymer such as residual ionic charges and molecular sizes (i.e. they retain the physiological properties of native chitosan). The methodology described herein is simple, cost-cutting, easy to use and far-reaching. It allows a quick, efficient and quantitative recovery of chitosan from acidic aqueous solutions with a minimum of easy-to-perform operations while preserving the integrity of the product. The methodology can be applied without limitations with respect to the amount of dissolved chitosan that needs to be processed allowing the method of the present invention to be developed for small scale, large scale or ultra high scale preparation for commercial production. Furthermore, chitosan preparations purified by means of the present invention are suitable for human or animal consumption when a food compatible salting out salt is used to salt chitosan out of solution. In addition, the present invention is not limited to the addition of one salt or to the use of only one type of salt (e.g. kosmotropic salts). Mixtures of salts (e.g. chaotropic and kosmotropic salts) may also be used, as long as the global effect is the salting out of chitosan from an aqueous acidic solution. This is of considerable importance in cases of application related to administration of chitosan to humans and animals such as applications related to the biomedical and food industries.

While the invention has been described with reference to certain illustrative embodiments, those skilled in the art will appreciate that various modifications, changes, omissions and substitutions can be made without departing from the spirit and nature of the invention. For example, the effective amount of salting out salts or organic salts required to cause salting out of a specific chitosan depends on a number of factors including the concentration of chitosan in the aqueous acidic solution, the temperature, the inorganic or organic salt used, the molecular weight of the specific chitosan, its degree of acetylation which can vary between less than 1% to more than 70%, the pH of the solution and the ambient pressure. It is understood, therefore, that the invention is not limited to the particular embodiments disclosed, but is intended to cover modifications within the spirit and scope of the present invention as defined by the appended claims.

### REFERENCES

1. Beaulieu, C., Lacasse, S. and Leclerc, C. (2003) Potential use of chitosan in agriculture: growth stimulation and biological control of plants disease. 9^{th} International Chitin-Chitosan Conference, Montreal, Quebec, Canada, August 27-30.
2. Brzezinski, R. (1996) Enzyme of use in chitosan hydrolysis. U.S. Pat. No. 5,482,843.
3. Chen, X. G., Lee, C. M. and Park, H. J. (2003) Emulsification for the self-aggregation and nanoparticle formation of linoleic acid-modified chitosan in the aqueous system. Journal of Agriculture and Food Chemistry 51: 3135-3139.
4. Cacace, M. G., Landau, E. M. and Ramsden, J. J. (1997) The Hofmeister series: salt and solvent effects on interfacial phenomena. Quarterly Review of Biophysics 30: 241-277.
5. Chiou, M. S, and Li, H.-Y. (2003) Method of adsorbing dye in aqueous solution by chemical cross-linked chitosan beads. United States Patent Application no. 20,030,101,521.
6. Collins, K. D. and Washabaugh, M. W. (1985) The Hofmeister effect and the behaviour of water at interfaces. Quarterly Review of Biophysics 18: 323-422.
7. Curotto, E. and Aros, F. (1993) Quantitative determination of chitosan and the percentage of free amino groups. Analytical Biochemistry. 211: 240-241.
8. Hofmeister, F. (1888) Zur Lehre von des Wirkung des Saize. II. Naunyn-Schmiedebergs Archiv für Experimentelle Pathologie und Pharmakologie (Leipzig) 24: 247-260.
9. Hugerth, A., Caram-Lelham, N. and Sundelöf, L. O. The effect of charge density and conformation on the polyelectrolyte complex formation between carrageenan and chitosan. Carbohydrate Polymers 34: 149-156.
10. Ikan, R. (editor) (1996) The Maillard reaction. John Wiley & Sons, New York, N.Y., USA.
11. Ito, M., Ban, A. and Ishihara, M. (2000) Anti-ulcer effects of chitin and chitosan, healthy foods, in rats. Japanese Journal of Pharmacology 82: 218-225.
12. Kunz, W., Henle, J. and Ninham, B. W. (2004) ‘Zur Lehre von des Wirkung des Salze’. (about the science of the effect of salts): Franz Hofmeister's historical papers. Current Opinion in Colloid and Interface Science 9: 19-37.
13. LeHoux, J. G. and Grondin, F. (1993) Some effect of chitosan on liver function in the rat. Endocrinology 132: 1078-1084.
14. Maeda, Y. and Kimura, Y. (2004) Antitumor effects of various low-molecular-weight chitosans are due to increased natural killer activity of intestinal intraepithelial lymphocytes in sarcoma 180-bearing mice. Journal of nutrition 134: 945-950.
15. Muzzarelli, R. A. (1998) Colorimetric determination of chitosan. Analytical Biochemistry 260: 255-257.
16. Neugebauer, W. A., Neugebauer, E. and Brzezinski, R. (1989) Determination of the degree of N-acetylation of chitin-chitosan with picric acid. Carbohydrate Research 15: 363-367.
17. O'Brien, J., Nursten, H. E., Crabbe, M. J. C. and Ames, J. M. (editors) (1998) The Maillard reaction in food and medicine. Royal Society of Chemistry, Cambridge, UK.
18. Roberts, G. A. F. (1992) Chitin chemistry, MacMillan Press Ltd, Houndmills, Hampshire, UK. page 281.
19. Roy, K., Mao, H. Q., Huang, S. K. and Leong, K. W. (1999) Oral gene delivery with chitosan-DNA nanoparticles generates immunologic protection in a murine model of peanut allergy. Nature Medicine 5: 387-391.
20. Shu, X. Z., and Zhu, K. J. (2002) The influence of multivalent phosphate structure on the properties of ionically cross-linked chitosan films for controlled drug release. European Journal of Pharmacology and Biopharmacology 54: 235-243.
21. Sorlier, P., Hartmann, D. J., Denuzière, A. Viton, C. and Domard, A. (2003) Preparation and development of anti-chitosan antibodies. Journal of Biomedical Material Research 67A: 766-774.
22. Sugano, M., Yoshida, K., Enomato, K. and Hirano, S. (1992) Hypocholesterolemic activity of partially hydrolyzed chitosans in rats. In Advanced in Chitin and Chitosan, (C. J. Brine, P. A. Sanford, and J. P. Zikakis, editors.) Elsevier, London, UK 472-478.

What is claimed is:

1. A method for precipitating chitosan comprising: mixing in any order an aqueous acidic solution containing a chitosan polymer and at least one inorganic or organic salt wherein said inorganic or organic salt is present in an amount effective to salt out said chitosan polymer to form an aqueous composition which comprises at least said salted out chitosan polymer.

2. A method as in claim 1, wherein said inorganic or organic salt is food-compatible or suitable for biomedical applications.

3. The method of claim 1, wherein said aqueous acidic solution has a pH between about 2 and about 6.

4. The method of claim 1, wherein precipitation is carried out between about 4° C. and about 55° C.

5. The method of claim 1, wherein said inorganic or organic salt is selected from the group consisting of ammonium or sodium sulfate, sodium or potassium phosphates, sodium or potassium citrate, sodium tartrate, sodium malate, sodium nitrate, sodium lactate, sodium malonate, sodium succinate, sodium acetate, and sodium propionate.

6. The method of claim 1, wherein said aqueous acidic solution is selected from the group consisting of acetic acid, lactic acid, malic acid and hydrochloric acid.

7. The method of claim 1, wherein a combination of at least two inorganic or organic salts is used.

8. The method of claim 7, wherein said combination of salts is a combination of kosmotropic and chaotropic salts.

9. The method of claim 1, wherein the amount of chitosan precipitated is at least 90% of the amount of chitosan in solution.

10. The method of claim 1, wherein said chitosan polymer has a molecular weight of about between 7 kDa and several hundreds kDa.

11. The method of claim 1, wherein said chitosan polymer has a degree of acetylation of between about 0% and about 50%.

12. The method of claim 1, wherein said salted out chitosan is washed with water and separated from said aqueous acidic solution by centrifugation.

13. A chitosan preparation obtained by the method of claim 1.

14. The chitosan preparation of claim 13, wherein said preparation is suitable for human consumption and biomedical applications.

15. The chitosan preparation of claim 13, wherein said preparation is substantially free of chitosanase.

16. The chitosan preparation of claim 13, wherein said preparation is substantially free of salts.

17. The chitosan preparation of claim 12, wherein said chitosan has conserved its physicochemical properties after precipitation.

18. The chitosan preparation of claim 12, wherein said preparation is soluble in the aqueous acidic milieu of the stomach.

19. A chitosan preparation which:
i) is substantially free of chitosanase;
ii) is suitable for human consumption;
iii) is soluble in an aqueous acidic milieu such as in the stomach; and
iv) is substantially free of precipitating salts.
